(19) United States
(12) Patent Application Publication
(10) Pub. No.: US 2001/0045904 A1
(43) Pub. Date: Nov. 29, 2001

(54) RECREATIONAL FACILITY MANAGEMENT SYSTEM

(76) Inventor: ROBERT CURTIS SILZER JR., BRITISH COLUMBIA (CA)

Correspondence Address: FITCH EVEN TABIN AND FLANNERY, 120 SOUTH LA SALLE STREET, SUITE 1600, CHICAGO, IL, 606033406

(21) Appl. No.: 09/240,365

(22) Filed: Jan. 29, 1999

(51) Int. Cl. G01S 5/14; G08B 23/00

(52) U.S. Cl. 342/357.07; 340/573.1

(57) ABSTRACT

A recreational facility management system for monitoring users within a plurality of predefined areas of the facility for generating usage information. The described system and method may relate to a wide variety of recreational activities including golfing, hiking, skiing, and the like, during which users of the facility and participants in the various activities will desire information relating to the positioning of themselves and others in the recreational areas to determine locations relative to landmarks or other meaningful geographic markers. A monitoring network is coupled to a facility management processor which may be a personal computer (PC) located in a golf course club house in communication via a base station interface and hand-held communicators. A transmission link is provided for transferring information from the facility management processor to the hand-held communicators for sending information relating to the plurality of predefined recreational areas of the facility. The multiple hand-held communicators include embedded communicator processors, one each associated with each communicator for processing global positioning system (GPS) and radio frequency (RF) data received to relate information corresponding to the predefined areas for communicating usage information relating to the recreational facility.

### RESERVATION OF COPYRIGHT

A portion of the disclosure of this patent document contains material which is subject to copyright protection. The copyright owner has no objection to facsimile reproduction by anyone of the patent document or the patent disclosure as it appears in the Patent and Trademark Office patent file or records, as it becomes available to the public, but otherwise reserves all copyright rights whatsoever.

### BACKGROUND OF THE INVENTION

The present invention relates to a network of computer-based communication devices providing a recreational facility management system for monitoring users within a plurality of areas of the facility to generate usage information about the facility, and more particularly, to a golf course management system providing interactive communication and golf course usage information between a facility management processor which may be located in a golf course club house, and a multiplicity of portable hand-held communicators each having a graphical user interface.

A wide variety of outdoor physical and athletic activities are performed on and about associated recreational areas, such as golf courses, ski mountains, and state and national parks which may be geographically significant. Presently, boaters, hikers and other outdoor enthusiasts have used hand-held global positioning system (GPS) receivers to assist them in their activities. GPS systems have also been employed in connection with the game of golf, since it is often desired for the golfer to have readily available information relating to yardage from the fairway to the green and the pin, as well as other information relating to obstacles associated with the golf course. Accordingly, devices have been made employing GPS systems for use by such outdoor enthusiasts, providing tailored information relating to, e.g., a golfer's choice of clubs, scoring, statistics relating to the game play, and the like. Similarly, hikers have used GPS devices providing basic longitude and latitude information, allowing the storage of path landmarks, allowing hikers to retrace their path through the park in order to return to predetermined locations.

Additionally, systems have been developed with communications capabilities in addition to the GPS receivers, such as radio frequency (RF), and infrared (IR) data communications It has been observed, however, that a problem associated with multiple units is that the updating of user information, particularly graphic information, is burdensome. The ability to facilitate updating of graphic information in particular, is of importance in order to provide images tailored specifically to the environment in which the devices are being employed. When being used as golf course management devices for example, each golf cart, and for that matter each hole of each golf course, requires illustration of unique layout of the landscape image information in order to provide the user with a realistic view of the hole. Similarly, ski slopes with particular runs and a chairlift landmarks would require images unique to the particular mountain or park. Additionally, even after initial images are provided for a particular recreational area, it is not uncommon for the layout of the environment to change periodically. For example, in the case of golf course management, the pin location on the green is often changed as frequently as on a daily basis. Therefore, it would be desirable to provide a software application which facilitates and simplifies the updating of information across various components of the system.

### SUMMARY OF THE INVENTION

In accordance with one described embodiment of the invention, a hand-held communicator is provided as a computer-based electronic device connected to the GPS satellite network. The use of the satellite network with differential GPS (DGPS) through the use of GPS signals received at a monitoring base station and at the hand-held communicators, provides accurate positioning on the order of feet. Integrated with the GPS positioning system within each communicator is hardware and software for translating the latitude and longitude information that the satellites provide relating to user specific information, such as positioning of the user on the graphic images illustrated on the communicator display. To this end, each communicator is provided with a unique identifier in the described embodiment such that when the communicator is powered, the identifier is established to allow a facility monitoring processor, such as a personal computer (PC) running an application program to track any communicator located relative to the recreational facility grounds. In the described golf course embodiment, the communicator is provided with software for generating graphic displays of maps and information about the individual golf course. These maps are created using aerial photography and digitized for use by the system.

Updating of information in the communicators is facilitated when the communicators are returned to battery recharging cradles, which also provide data communications from the facility management processor. Accordingly, the communicators, when in their charging cradles, are linked to a computer network which sends information as described herein, in the form of data communications using a combination of wireless, infrared, and coaxial connections. The battery recharging process is also automated and the communicators are shut down when the batteries are fully charged. At any time, the facility management processor can determine the status of each communicator being charged When the communicator is in the charging cradle, communications is provided via infrared and coaxial cable, each communicator being remotely programmable from the facility management processor which facilitates central and remote programming of the communicators. Thus, the communicators are regularly updated for modified display information whenever they are recharged. When the communicator is taken out to the recreational area, a RF link is established to provide communication with a base station interface of the system.

In the described embodiment, the communication interface is a significant aspect of the system requiring reliable and proven network operation, and thus standardized Transmission Control Protocol/Internet Protocol (TCP/IP) is used as the communication protocol. This data communications network approach facilitates local area networks (LANS) as well as internet or intranet applications.

Briefly summarized, the present invention relates to a recreational facility management system for monitoring users within a plurality of predefined areas of the facility for generating usage information relating to a wide variety of recreational activities including golfing, hiking, skiing, and the like. Thus, participants in the various recreational activities are provided with information which is desired by users relating to the positioning of themselves and others in the recreational areas to determine locations relative to landmarks or meaningful geographic markers. A monitoring network is coupled to a facility management processor which may be a personal computer located in a central location such as a golf course club house. The facility management processor is in communication via a base station interface with the hand-held communicators. A transmission link is provided for transferring information from the facility management processor to the hand-held communicators in order to send information relating to the plurality of predefined recreational areas of the facility The multiple hand-held communicators include embedded communicator processors, one each associated with each communicator for processing global positioning system (GPS) and radio frequency (RF) data received to relate information corresponding to the predefined areas for communicating usage information relating to the recreational facility.

Various other advantages of the present invention will become apparent to one of ordinary skill in the art, upon a perusal of the following specification and claims in light of the accompanying drawings.

### DESCRIPTION OF THE DRAWINGS

FIG. 1 is a system diagram of an embodiment of a recreational facility management system, herein a golf course management system in accordance with the present invention;

FIG. 2 is a block diagram of the communicator hand unit;

FIG. 3 shows an exemplary layout of coordinates on an image on the display;

FIGS. 4A and 4B illustrate a software layer;

FIG. 5 is a block diagram of the Base Station Interface;

FIG. 6 is a block diagram of a charging cradle;

FIG. 7 is a perspective view of a hand-held communicator;

FIG. 8 is a perspective view of a battery charging carrier which receives the communicator of FIG. 7;

FIGS. 9A-9G are schematic diagrams showing the circuitry associated with the hand-held communicators;

FIGS. 10A-10F are schematic diagrams showing the circuitry associated with the battery charging carrier for receiving the hand-held communicators;

FIGS. 11A-11H are schematic diagrams for the circuitry associated with the base station interface;

FIG. 12 illustrates the personal computer display screen associated with the facility management processor;

FIG. 13 shows the personal computer display on the facility management computer illustrating a three-hole view in the described golf course embodiment;

FIGS. 14A and 14B illustrate the communicators and associated messages provided on the electronic LCD display; and

FIGS. 15-20 show various sets of graphic displays provided as bitmap images for use with the hand-held communicators.

### DESCRIPTION OF THE PREFERRED EMBODIMENT

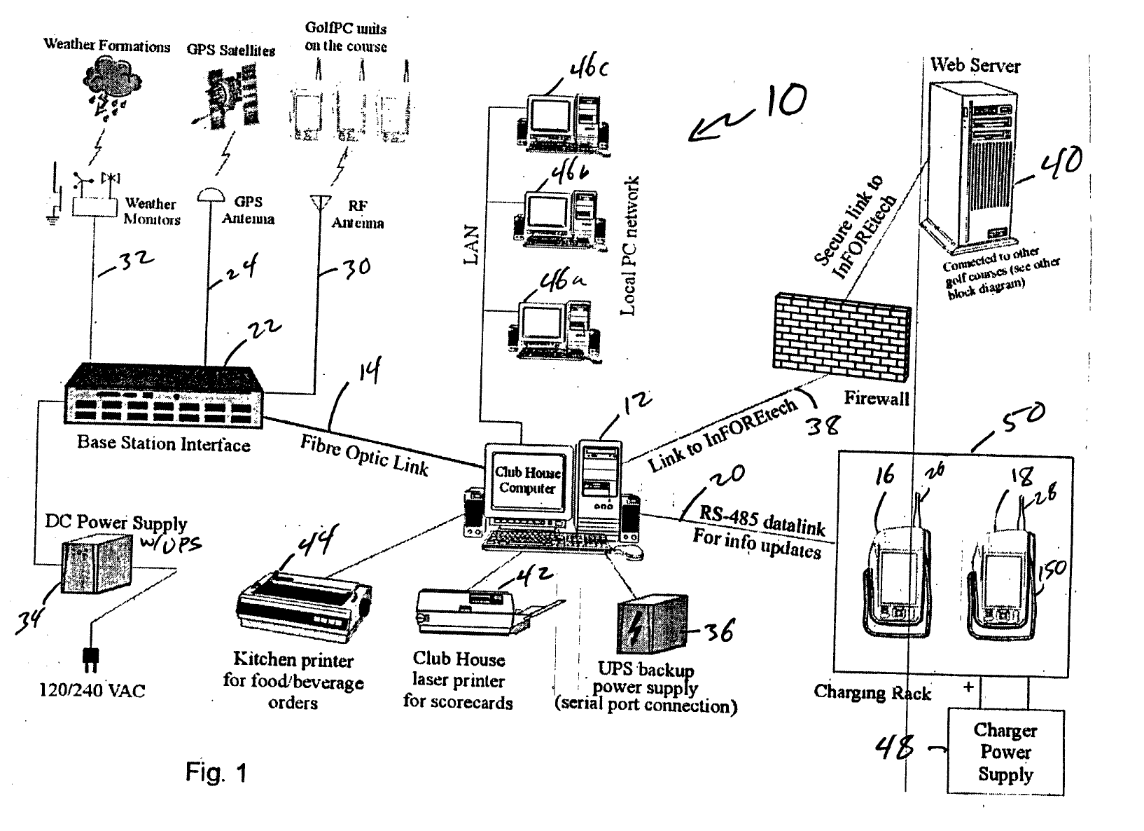

A recreational facility management system for monitoring users within a plurality of predefined areas of the facility is shown in FIG. 1 which illustrates a computer-based data communications for generating usage information for use by either a facility management processor or hand-held communicators as described below.

The overall system described in the present preferred embodiment includes seven (7) main parts:

1. Communicator Hand Unit

2. Clubhouse Computer

3. Base Station Interface

4. Charging Cradle

5. Communication Links

6. Server

7. Peripherals.

Referring to FIG. 1, a system diagram is shown for a recreational facility management system 10, herein a golf course management system. The seven main system components listed above correspond to the applicable described components in FIG. 1 of the described embodiment. As shown, a facility management processor 12 is coupled to a monitoring network 14, herein a fiber optic link which is used for data transmission and reception from a variety of monitoring sources discussed below As shown, a multiplicity of hand-held communicators 16,18 are provided for communicating information relating to the various predefined areas of the facility being monitored by the system 10. Each communicator 16,18, as described below, includes a global positioning system (GPS) receiver as well as RF receivers via antennas 26 and 28. As disclosed, the facility management processor 12 is coupled to several data transmission links which may be provided either as dedicated data links or local area networks (LANs) or wide area networks (WANs) as well as an intranet or internet networks providing Transmission Control Protocol/Internet Protocol (TCP/IP) as a network protocol providing communication with the facility management processor 12. Herein, the monitoring network 14 is provided as a fiber optic link to provide an isolated connection to the monitoring equipment, whereas a transmission link 20 is provided as a RS-485 datalink for serial communication of data to the communicators 16 and 18, which as described further below receive infrared data communications via the charging carriers which are coupled to the transmission link 20 in a charging rack 50 which is powered with a charger power supply 48.

The fiber optic link monitoring network 14 is coupled to a base station interface 22, discussed further below, which is powered with an uninterruptible power supply (UPS) 34 which provides DC power to the base station interface 22. A GPS reception antenna 24 is connected to a GPS receiver in the base station interface 22 for receiving GPS position data from GPS satellites in the vicinity of the predefined areas of the recreational facility. Radio frequency (RF) antenna 30 of the base station interface 22 is used for communication by and between communicators 16 and 18 in order to relay communications information and GPS information from the base station interface 22. The base station interface 22 also is coupled to weather monitors 32 for obtaining weather related information based upon the weather formations being generated in the vicinity of the recreational facility.

The facility management processor 12 is powered with a UPS backup power supply 36. The power supply 36 is also provided with a serial port connection for remote operation. The facility management processor 12 is coupled to an external network via a cable 38 which may be coupled either to an internet or infranet link which, for security purposes, may include a firewall to a server connection at, e.g., a web server 40. Additionally, the facility management processor 12 is provided with networking and input/output facilities including a local printer 42, a kitchen or service printer 44, as well as local personal computers 46a,b,c which may be provided via a local PC network. The management system 10 is a complete golf information system, which provides users of the recreational facility with important information including golf course pin distance and the like. Such information for other recreational facilities, such as ski mountains and parks for hiking and other outdoor activities, may provide users with GPS landmark and general information. The facility management processor 12, herein a personal computer (PC) is provided as a Clubhouse Computer that is able to locate an communicator hand unit anywhere on the golf course, provide statistical information about the course and every hole. It can speed up the pace of play by accurately giving the golfer vital information about the lie of the ball without overwhelming the golfer with unnecessary information. Each communicator will be almost fully automatic. A player could play a full round of golf without needing to access any of the hand units functions except to enter the scores for each hole.

The following features may be accessed by the player:

Distance to Landmarks and Hazards

View Pro Tips

Food Orders

Proshop Orders

Receiving Messages and Memos

View Promotions/Advertising

Weather Information

Rules

Tournament Information

Scorecard

Betting

Green contours and undulations

Directional compass.

The golf course management system is also a valuable tool for managing a golf course. It can pinpoint bottle necks on the course in real time. Provide additional revenues with advertisements on the hand unit and allowing the player to order food and golf supplies while on the course. The golf course management system will allow course administrators to view statistics about how the system is preforming through an expandable database of information.

### Communicator Hand Unit

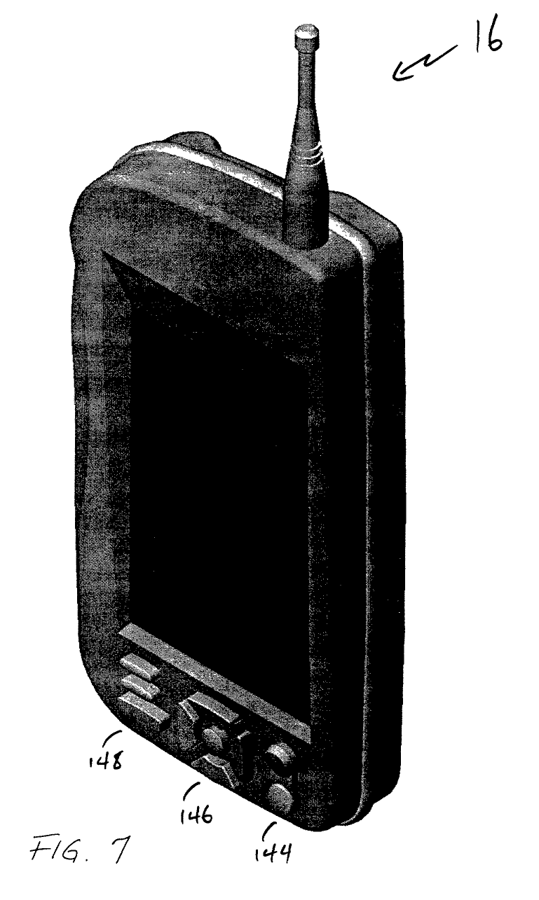

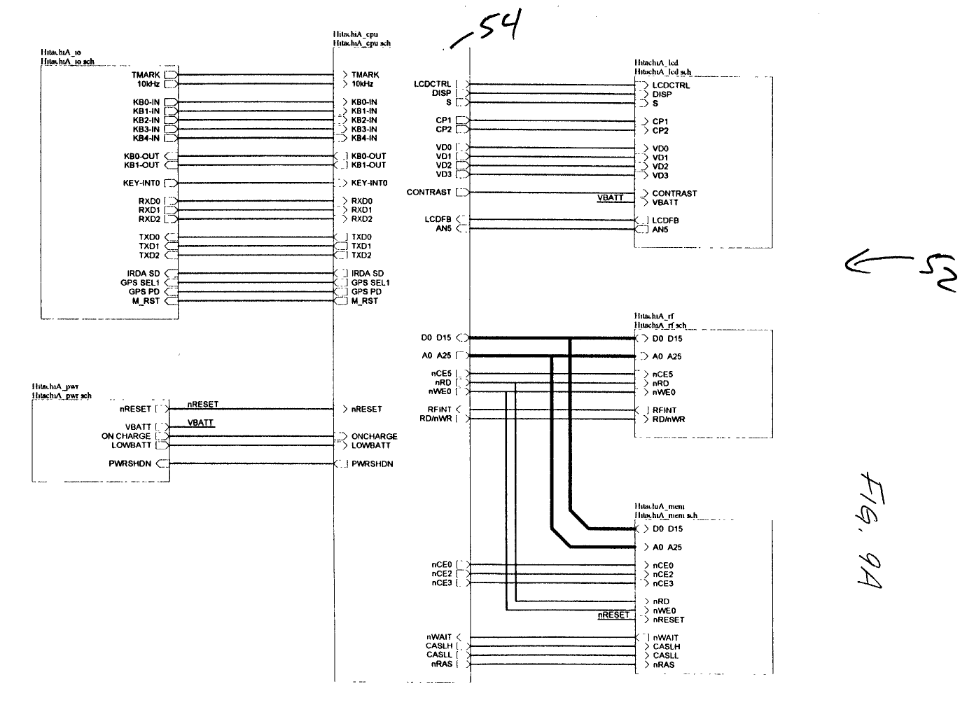

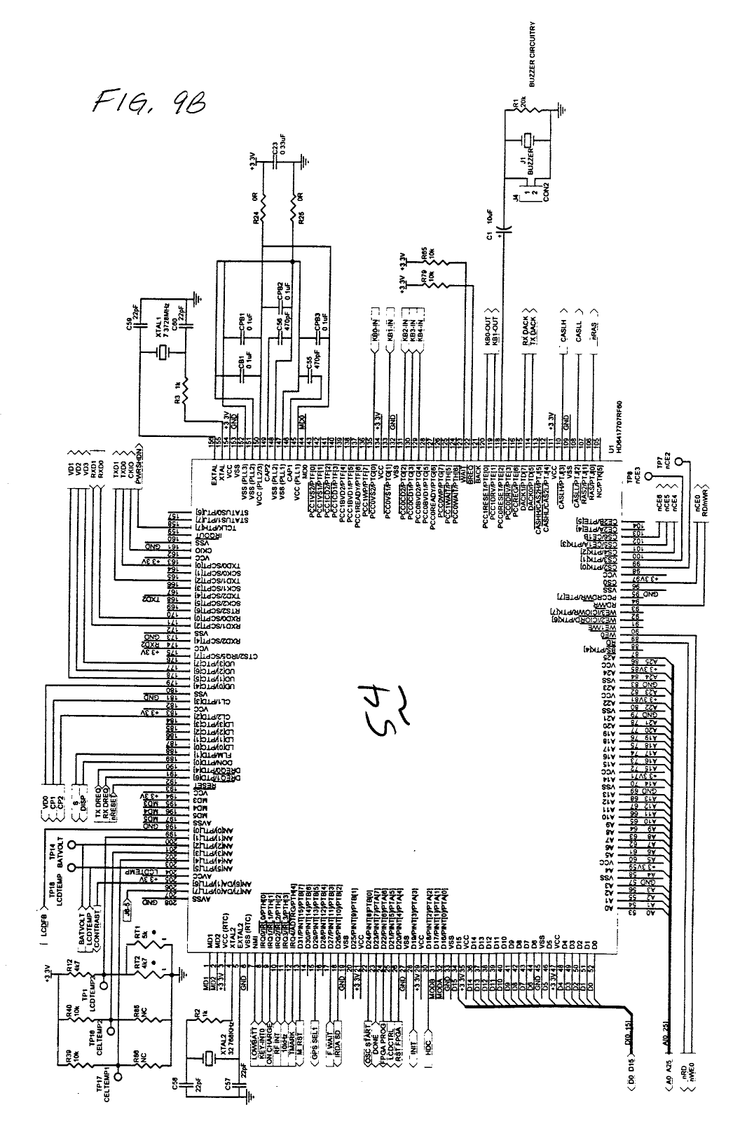

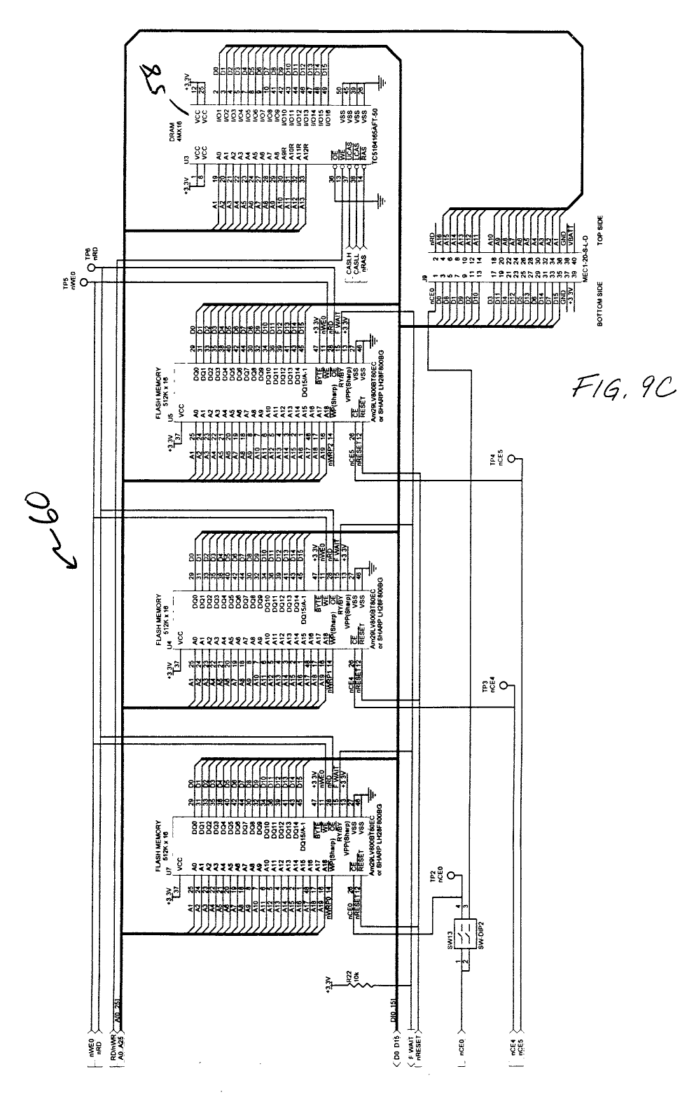

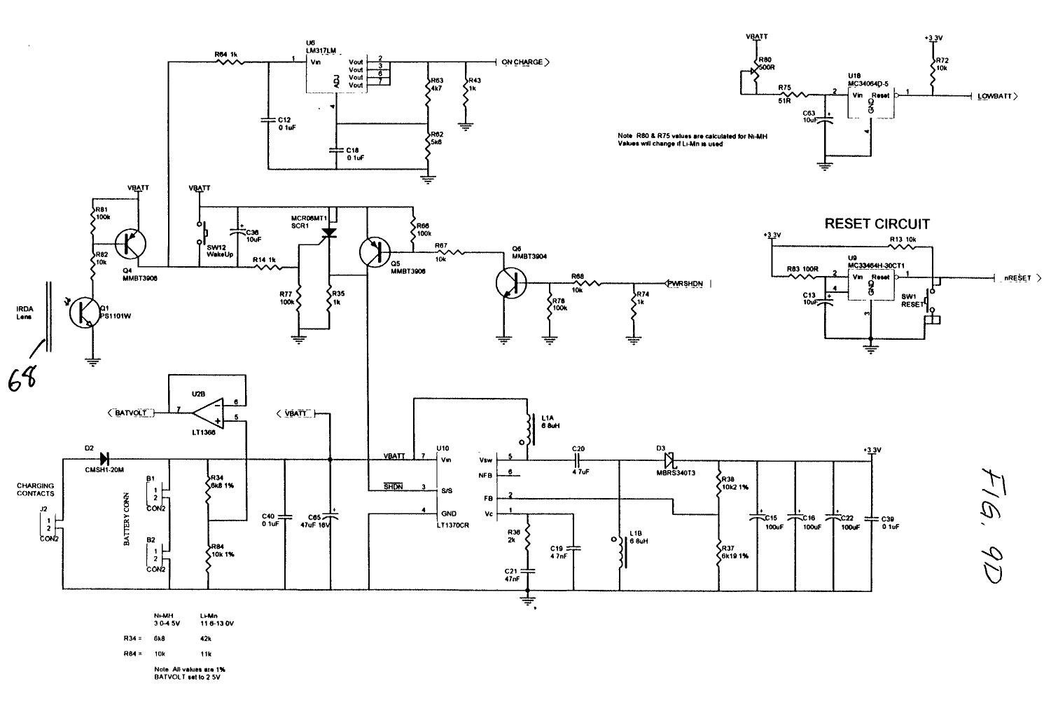

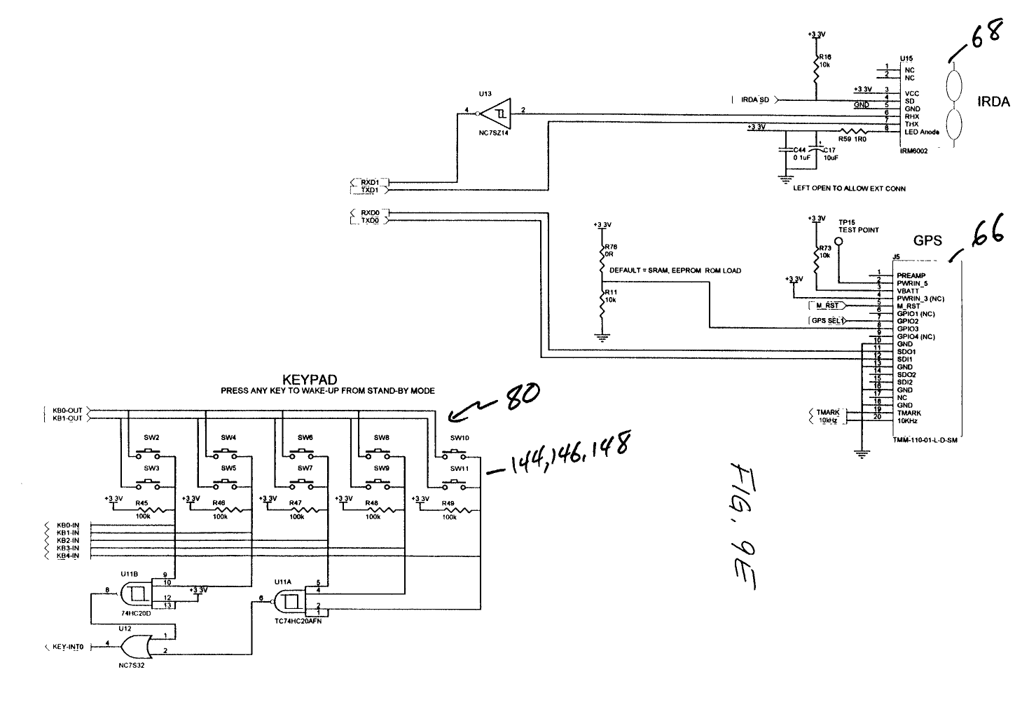

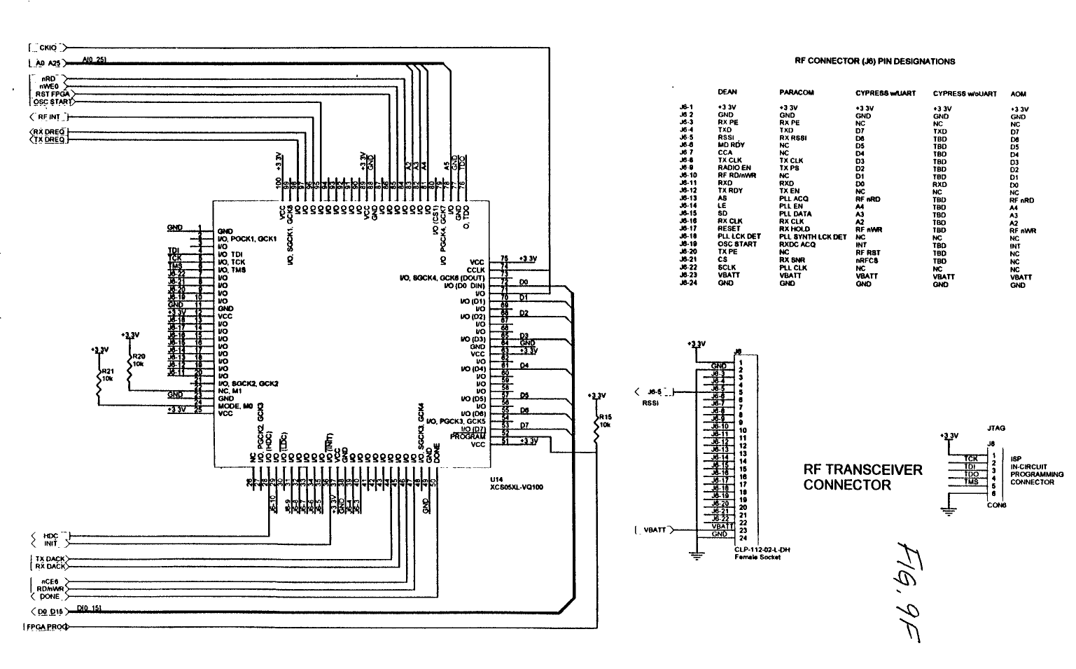

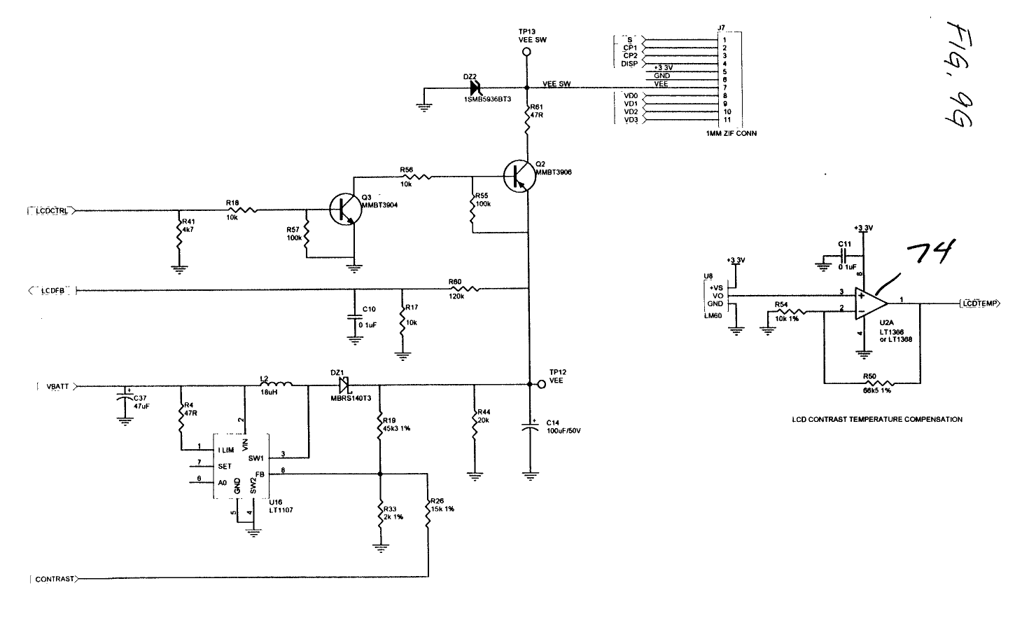

The communicators 16, 18 are hand-held devices which allow one to determine their position on a golf course as well as the relative locations of predefined landmarks. FIG. 7 is a perspective view of a hand-held communicator 16. The device will have the facilities to dynamically receive data through a RF receiver while out in the field. FIGS. 9A-9G are schematic diagrams showing the circuitry associated with the hand-held communicator 16.

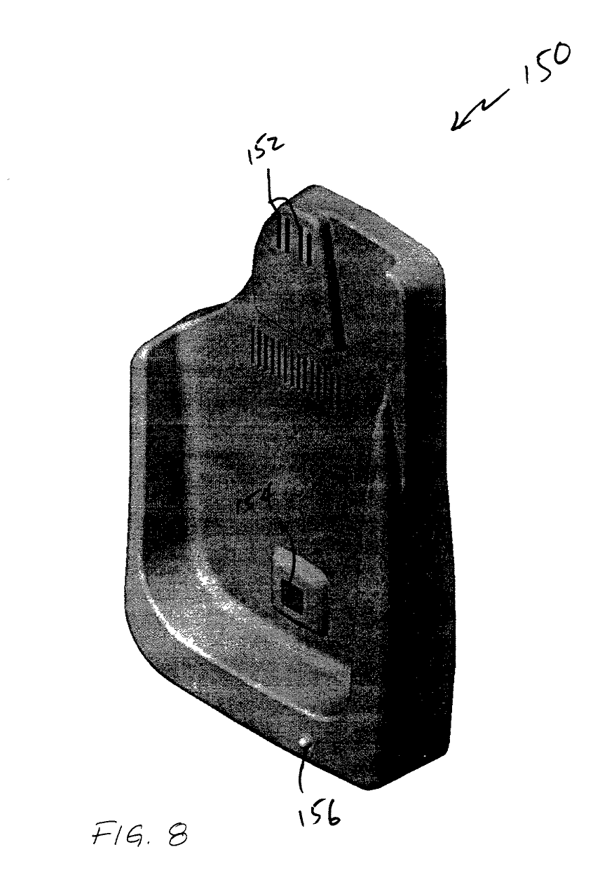

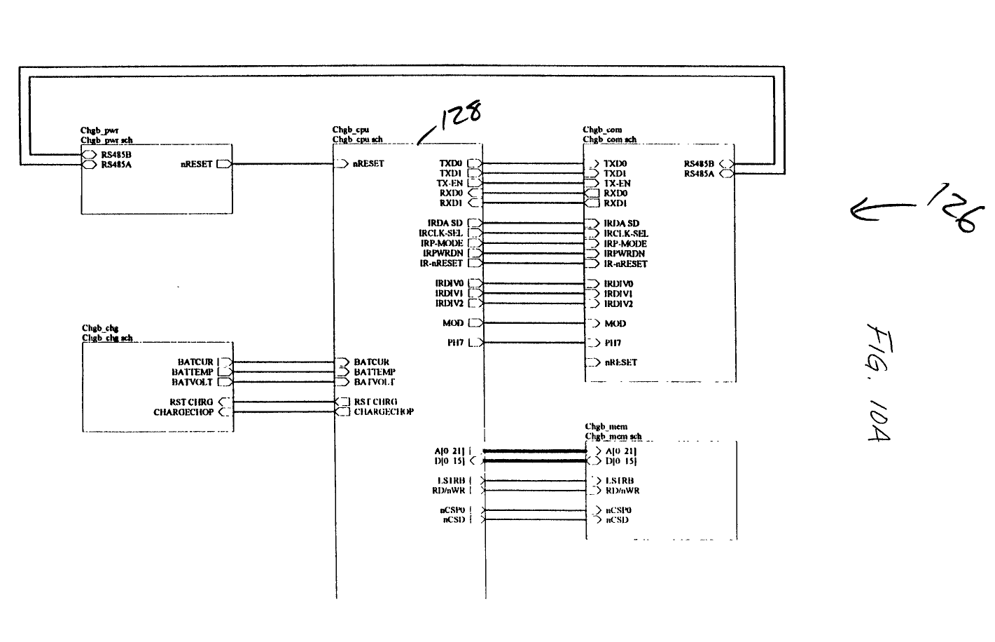

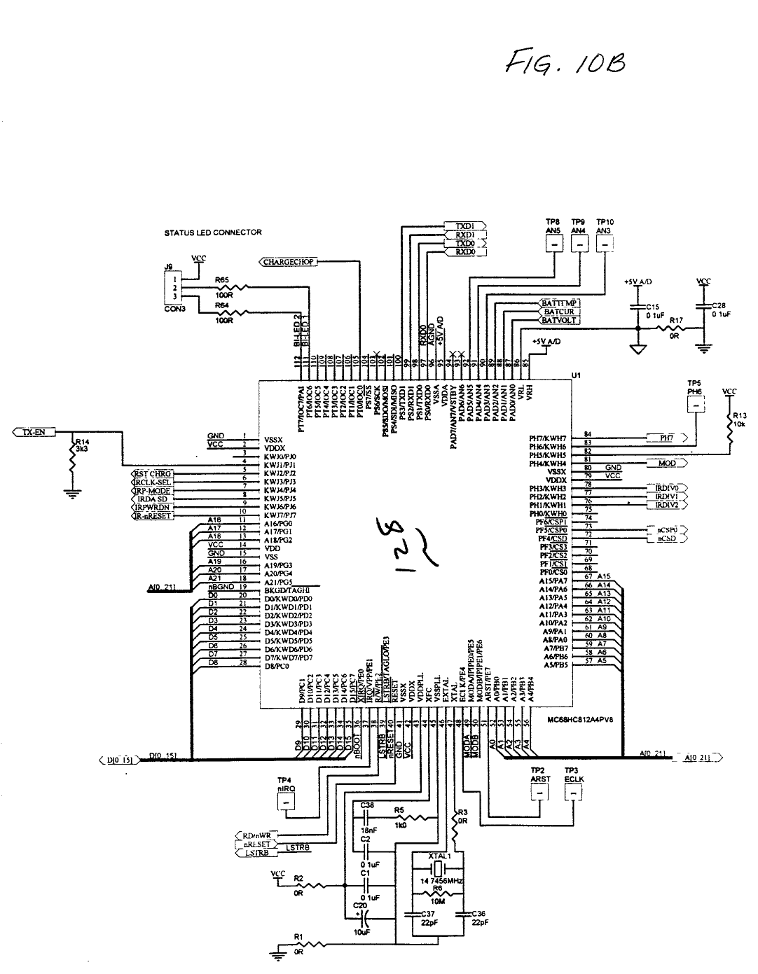

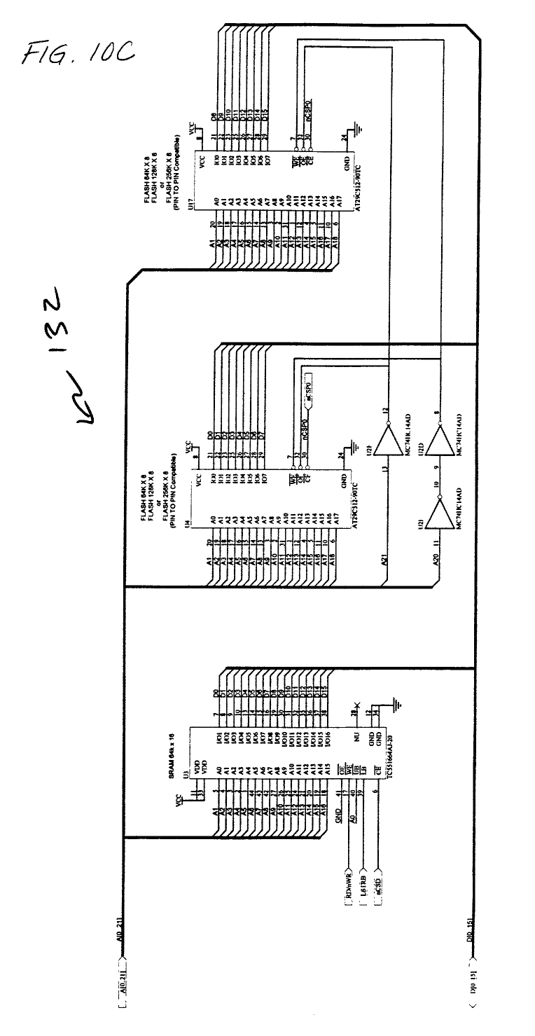

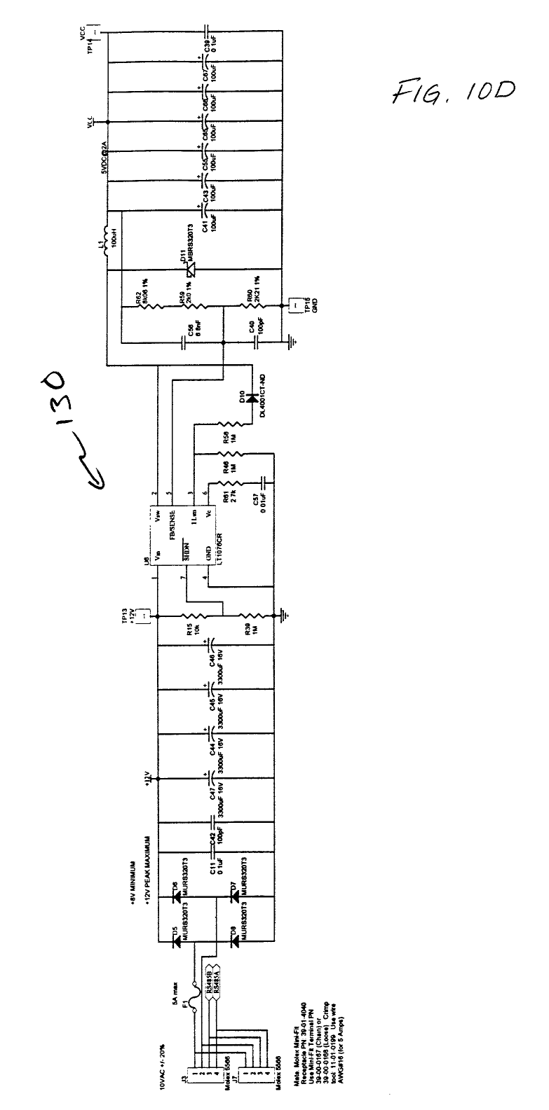

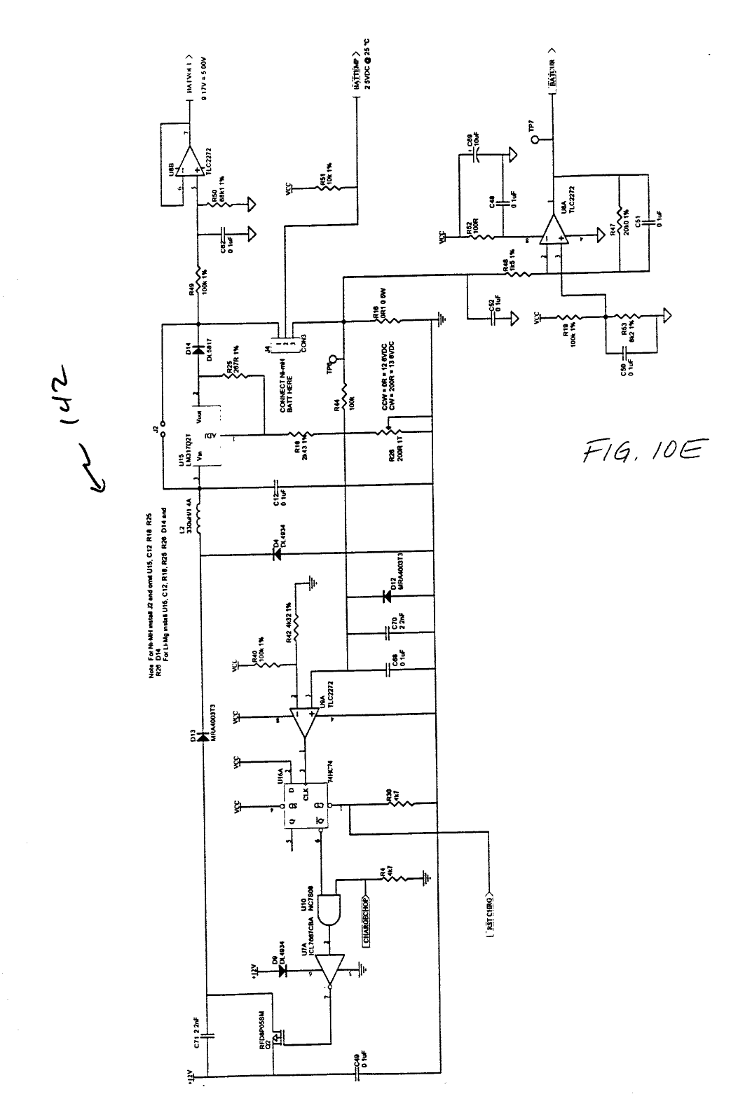

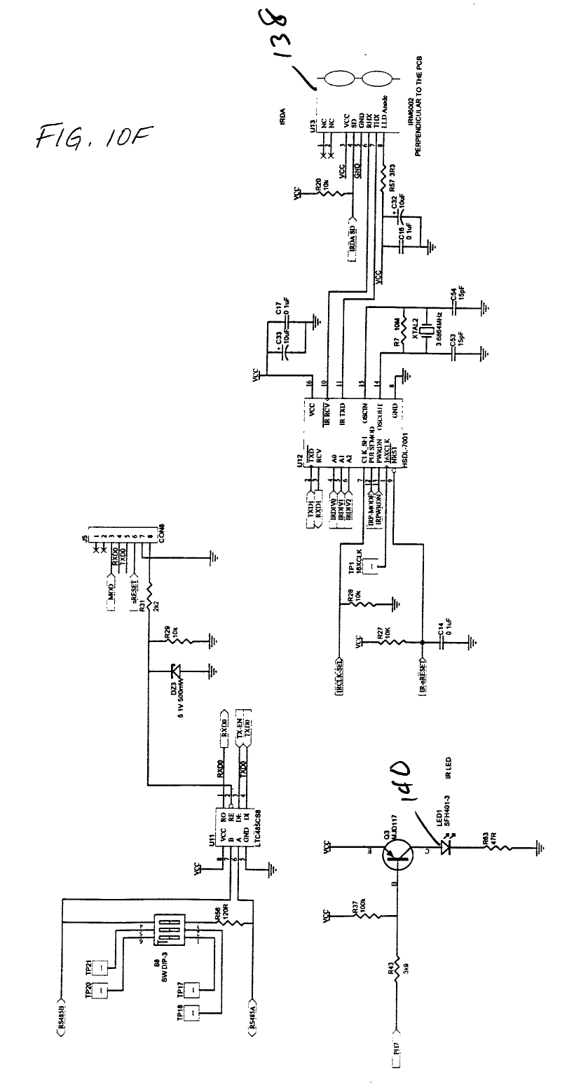

While a unit is charging in a cradle, each hand unit will be able to upload new course statistics, and download game statistics via infrared communications. FIG. 8 is a perspective view of a battery charging carrier which receives the communicator 16 of FIG. 7. FIGS. 10A-10F are schematic diagrams showing the circuitry associated with the battery charging carrier for receiving the hand-held communicator 16.

The current device will have a reflective monochrome LCD display but can be upgraded to a color LCD display in future versions. Software was developed to run on the communicator's RISC microprocessor. The software will handle all communications, Graphical User Interface (GUI), and interpret a scripting language. This scripting language will allow the device to behave differently by altering a script file that contains the unit's characteristics. A player can interact with the GUI through a ten-button keypad.

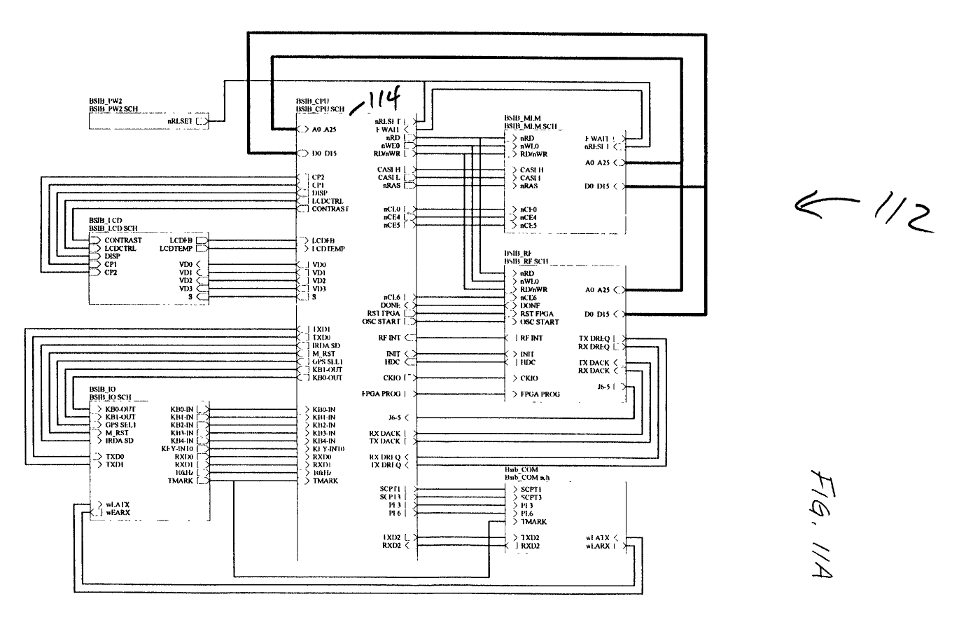

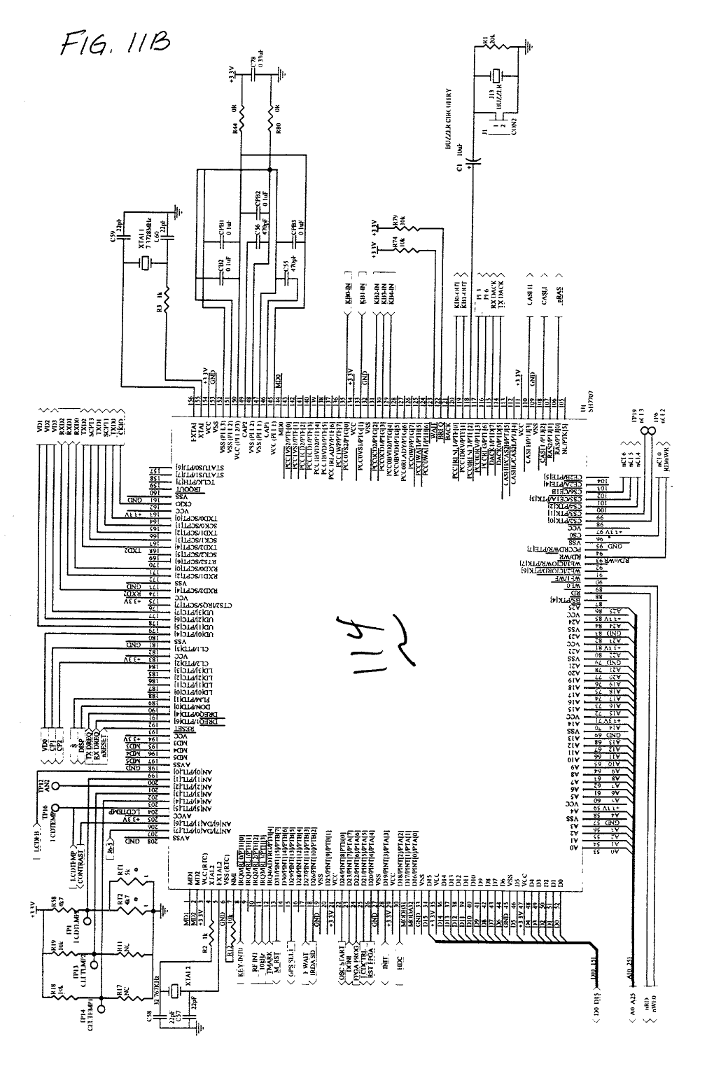

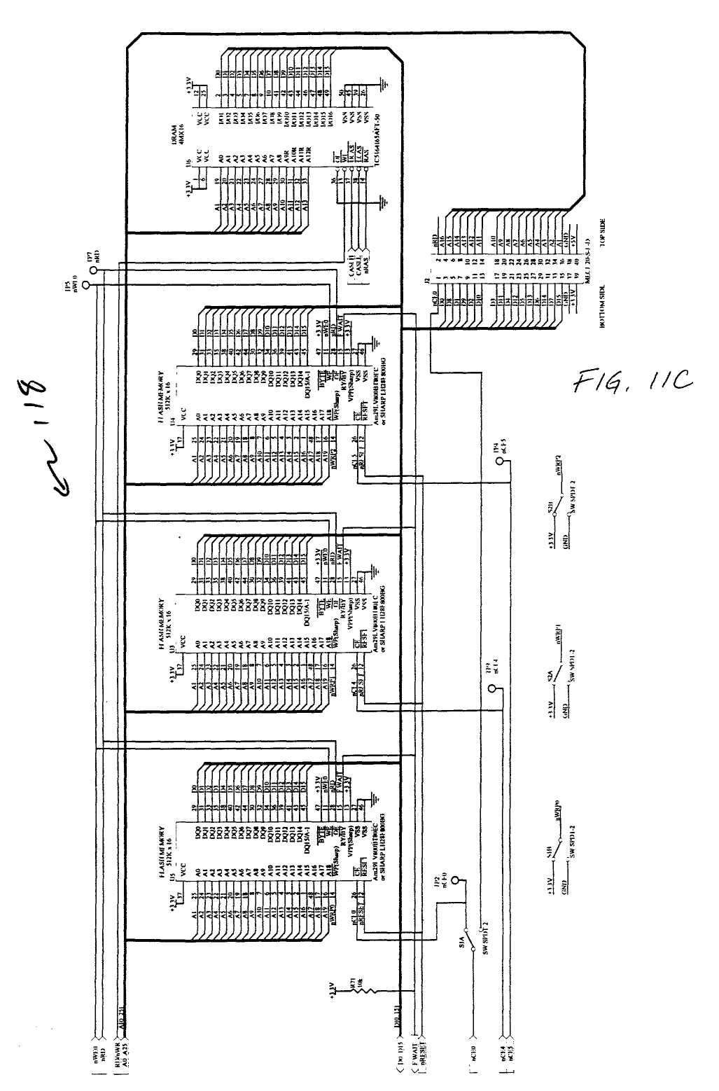

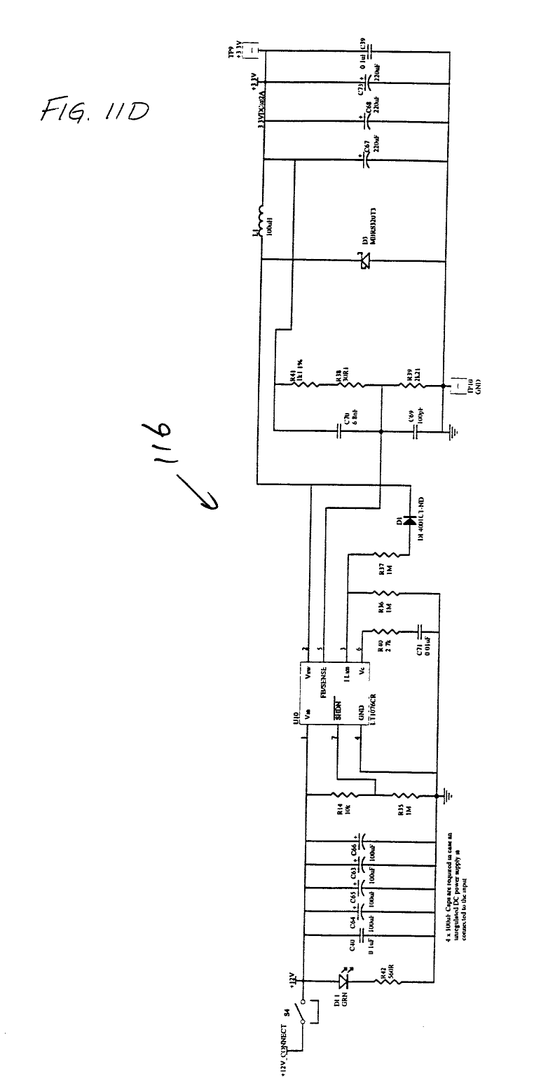

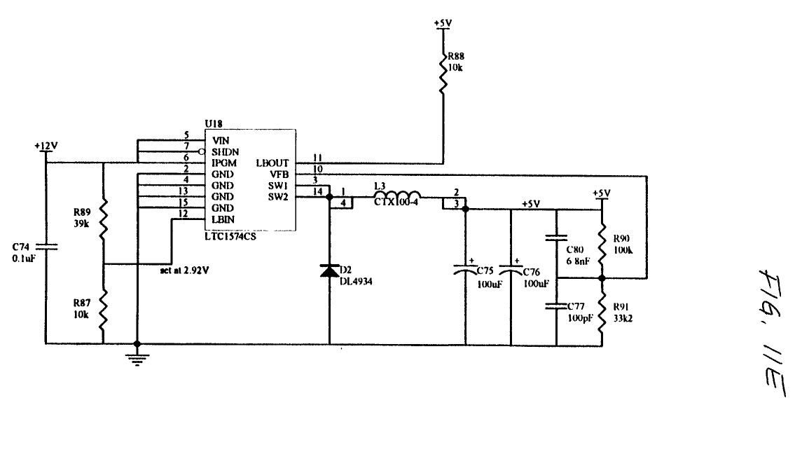

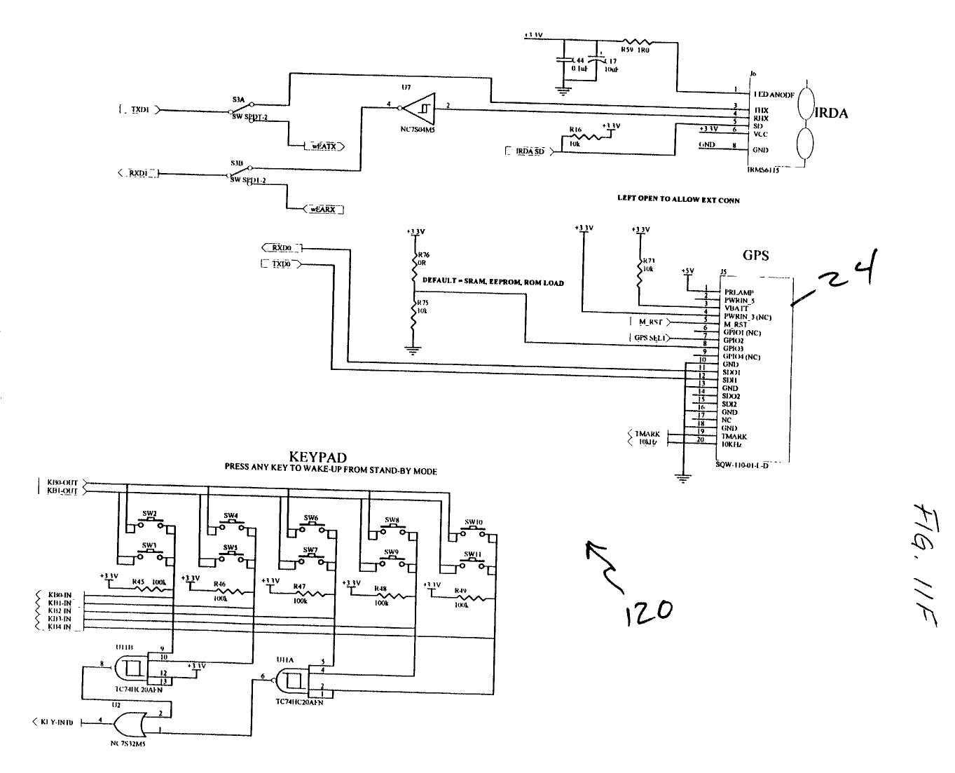

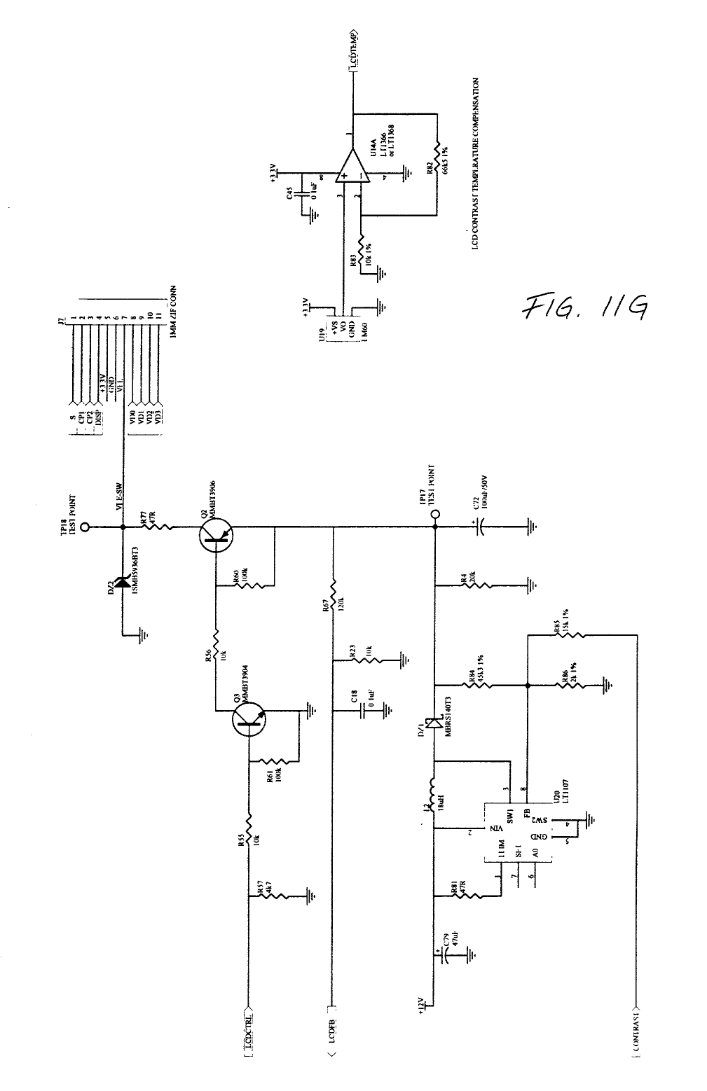

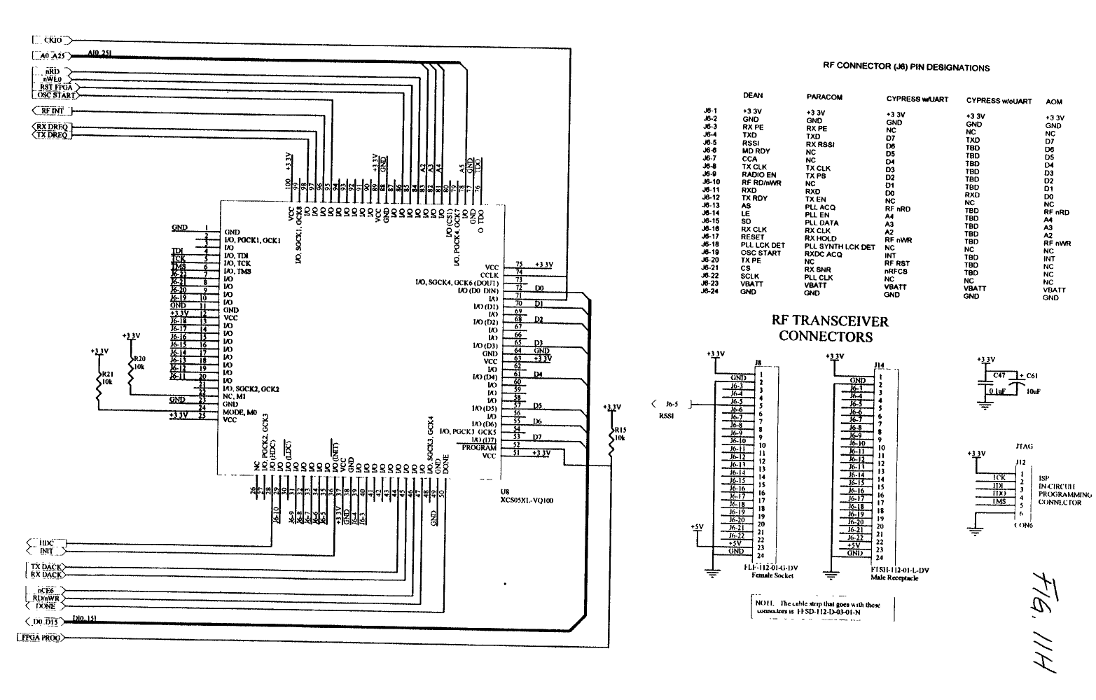

The communicator will also be able to send information to a Base Station Interface (BSI). FIGS. 11A-11H are schematic diagrams for the circuitry associated with the BSI, as discussed below.

The communicator hand unit is made up of twelve major sections:

1. GPS Receiver

2. DGPS Correction

3. Digital Compass

4. RF Module

5. CPU

6. Memory

7. Charging Cradle Detection

8. IRDA Link

9. GUI

10. Software

11. Batteries

12. LCD Display

13. LCD Contrast Control

14. Keypad

15. Speaker

16. Mechanical Components.

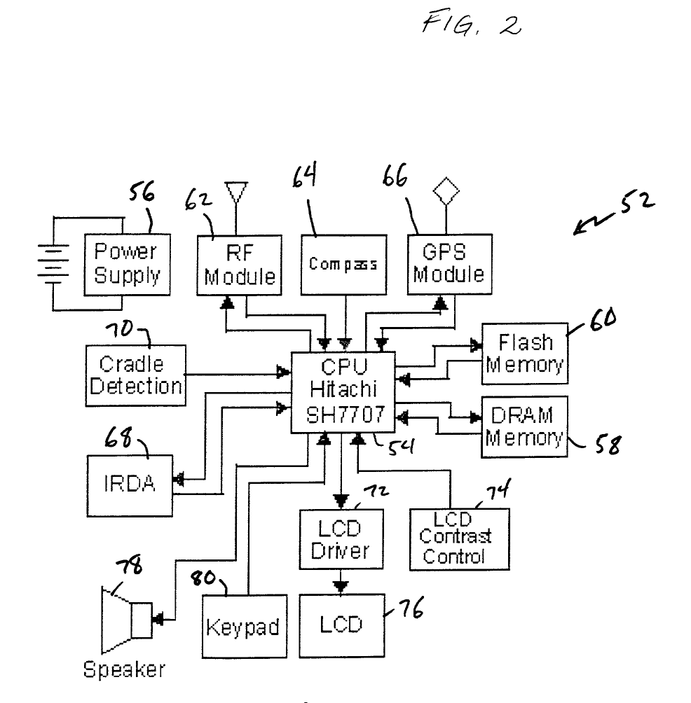

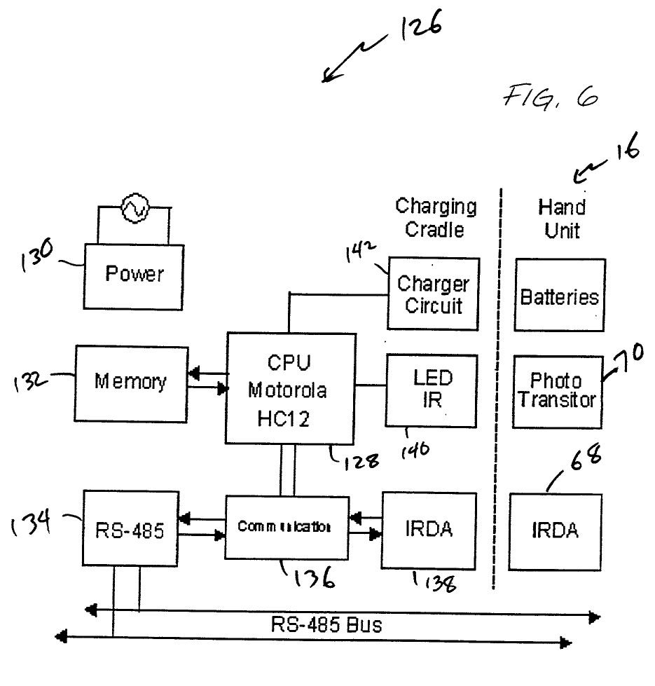

FIG. 2 is a component level block diagram of the communicator hand unit. The circuitry 52 of the hand unit 16 is further detailed in FIGS. 9A-9G, as described below. The communicator circuitry 52 is controlled with a Hitachi microcontroller, herein SH7707, which has onboard DAC/ADC and LCD interfaces on a single chip running a real time C++operating system with standard TCP/IP and SLIP communications protocols. A power supply 56 provides power control to the circuitry 52. Volatile and nonvolatile data storage is provided with a DRAM memory circuit 58 and FLASH memories 60. As discussed, each communicator also includes an RF module 62, a digital compass 64, and a GPS module 66 which are described herein to maintain communications between the user and the recreational facility management processor to provide location information to the user. An infrared data communication channel to the communicator 16 is provided with a IRDA 68 which is used with a cradle detection circuit 70. The cradle detection circuit 70 is provided as infrared light detection which detects a pulsing infrared light signal provided by the charging cradle 126 of FIGS. 6 and 10F, wherein an infrared LED 140 is employed as a pulse code modulated signal from the charging cradle which is received by the cradle detection circuitry 70 to activate the communicator circuitry 52. Thus, the cradle detection circuitry 70 may be used in connection with power management of the circuit 52 as well. An LCD driver 72 under the control of the microcontroller 54 is controlled in connection with an LCD contrast control circuit 74 to control the LCD electronic display 76, in which, as shown in FIG. 9G, a LCD contrast temperature compensation circuit 74 is provided with feedback for varying the LCD contrast depending on the outdoor temperature conditions Additionally, the communicator provides a user interface in addition to the graphical user interface which includes audio speaker 78 and keypad 80 which provides various keys 144, 146 and 148 as shown in FIGS. 7 and 9E.

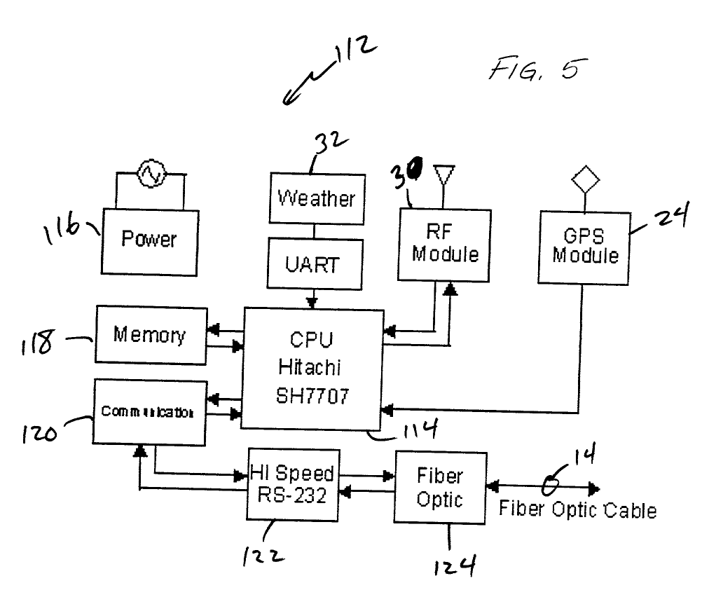

With reference to FIG. 5, the base station circuitry 112 of the base station interface (BSI) 22 is provided with a core processor unit similar to that of the communicator 16, which also is controlled with a Hitachi SH7707 microcontroller 114. As discussed further below, circuit 112 as detailed in FIGS. 11A-11H provide circuitry associated with interfacing the various signal and communications peripherals to the facility management processor 12. The BSI circuitry 112 includes power control circuitry 116, memory circuitry 118, and communications circuitry 120 for providing both data communications and a user interface to the BSI 22. High speed data communications is provided with a serial RS-232 link 122 via a fiber optic channel 124 to the fiber optic cable 14.

As detailed in the circuitry of FIGS. 10A-10F, the charging cradle is controlled with a Motorola microcontroller, herein Motorola HC12, microcontroller 128. The Motorola microcontroller 128 is the heart of the charging system which employs a conventional Buck regulator charging the batteries of the hand unit 16 via the charger circuit 142. The circuit 126 of the charging cradle is controlled with power circuitry 130; additionally the microcontroller 128 is provided with volatile and nonvolatile memory 132. Communications to the circuit 126 of the battery charger is provided via a communications bus, herein a RS-485 bus, interfaced via a RS-485 interface controller 134 which communicates with the microcontroller 128 via a communications block 136, also providing infrared data communications via IRDA 138. The infrared LED 140, as discussed, provides cradle detection to the communicator 16 via the cradle detection circuitry 70. With reference to FIG. 8, the charging cradle housing 150 receives the communicator 16 at magnetic charging contacts 152 which provide power for recharging the batteries of the communicator 16, as well as securing the communicator in the charging cradle of the charging cradle 150 of the charging rack 50. An infrared transmissive window 154 provides for the infrared data communications between the charging circuitry 126 and the communicator circuitry 52. An LED 156 also provides an indication of active charging of the communicator 16 in the charging cradle 150.

### GPS Receiver

Each communicator is equipped with a Rockwell Jupiter GPS module. This allows each device to receive locating information from a constellation of 21 active satellites and three spares. Each of these satellites has a very accurate atomic clock transmitting a signal that is received by the GPS receiver. The receiver deciphers the signal from at least three different satellites to determine the receiver's location. A four signal needs to be decoded, to determine its location along with elevation. A position update can be more than once per second.

The satellites transmit two different codes: Precision (P) code and the Coarse Availability (C/A) code. The P code is a special code used by the US military. All commercial GPS modules operate using the C/A code. This code is not as accurate as the P code and the US government adds a randomizing signal called Selective Availability to the C/A code to further degrade the accuracy. But methods such as Differential GPS (DGPS) have been devised to make commercial GPS modules more accurate than the P code.

Most GPS modules give their location in the format of Longitude, Latitude, and elevation (Geodesic). The Jupiter modules can output in this format as well as in a different coordinate system called Earth Center Earth Fix (ECEF). Its format is an x, y, and z position in meters relative to the center of the Earth. Competitive systems currently on the market only make reference to the geodetic coordinate system and not the Earth Center Earth Fix coordinate system.

The communicator will use GPS for three functions. In normal mode, the GPS will allow each device to determine its location on a map. From this information and information about landmarks stored in the device's memory, the distance to the landmarks can be calculated and displayed on the screen.

The second function is to attach a unit's location and cutlined regions on to a map. Once the unit crosses into one of the outlined regions, a message is sent to the unit's microprocessor to execute a special action. At this time a message may also be sent via the RF link to the base station interface and from there, relayed to the Clubhouse Computer (CC). This will allow the CC to track each communicator and determine its location on the map.

The third function is for administrative use. This function allows a unit to mark special locations on the map. For instance, marking a new hole location on the green or even outlining a new region (as mentioned above) on a given map.

### DGPS Correction

Differential GPS is used to counteract the inaccuracies of standard C/A code GPS. Many factors contribute to these inaccuracies such as: Selective Availability, atmospheric delays, multipath signals, receiver errors, satellite clock inaccuracies, and satellite drift.

DGPS uses a regular GPS receiver module at a known fixed location for reference This receiver does not move and will be referred to from here on as the DGPS receiver. The fixed GPS antenna may be set to either survey the actual position or gather readings over a period of time. These readings are then averaged to calculate the actual location. Once the actual location has been determined, the fixed GPS antenna takes readings of its current apparent location. Then this apparent location is compared to the known fixed location with a method called pseudo range correction to calculate the GPS correction factor. This GPS correction is then formatted into an RTCM packet and transmitted using User Datagram Protocol (UPD) in an Internet Protocol (IP) packet, over the RF link. This process is repeated over and over again. A field communicator hand unit's accuracy is determined by the number of correction packets it receives. The accuracy using DGPS should be 1 meter.

Each communicator Hand unit in the field receives a correction packet and then passes it to the Rockwell Jupiter GPS module The GPS module applies this correction data to the apparent location, read from the GPS receiver, to provide a more accurate location reading. The Jupiter module then outputs a location reading to the communicator, where it is eventually displayed on the LCD display.

### Digital Compass

A special feature of the communicator is its digital compass. The digital compass is a very sensitive circuit that will enable each unit to determine its orientation relative to North or True North, depending on the software.

The compass will use a small arrow located in the corner of the LCD display to show the golfer the direction to the next hole. Additional uses for the digital compass was implemented

The compass that may be used is a magnetoresistive sensor that detects both the sign and magnitude of the Earth's magnetic field as a voltage output. This type of sensor is sensitive enough to obtain readings within the milligauss range and take multiple reading per second. The magnetic sensor output will have an X, Y, and Z component referenced to the magnetic sensor, or compass package.

The current system does not compensate for tilt of the compass. But bases on field testing and research on viable solid state solutions, a tilt sensor could be incorporated into the system in the future.

The compass works by sensing the Earth's magnetic field (which is about 0.5 to 0.6 gauss). Any metallic objects near the compass will effect its performance.

### RF Module

The RF module is used to stream and burst information to an individual hand unit, a group of hand units or all hand units. To make the most efficient use of the limited bandwidth, both Transmission Control Protocol (TCP) and User Datagram Protocol (UDP) may be used in conjunction with Internet Protocol (IP). TCP is used for information that needs to get to the destination without any errors. UDP is used for information that is not essential to the operation of the unit or if the information is to be repeated in the near future.

The RF module will use a wide band spread spectrum technology. There are two types of spread spectrum technology: Frequency Hopping Spread Spectrum (FHSS) and Direct Sequencing Spread Spectrum (DSSS).

FHSS uses a narrow band RF frequency to transmit, similar to a normal narrow band radio. But, FHSS switches the transmit frequency many times a second in a seemingly random manner The name frequency hopping come from the fact that the transmit frequency hops around the spectrum The frequency changes actually follow a preset sequence Since the transmit frequency is constantly changing, it adds a level of security to the system.

DSSS is a truly wide band technology. It utilizes the whole allotted bandwidth to transmit. A special code sequence, Pseudorandom Noise (PN), is generated by the transmitter and mixed with the information to be transmitted. The key point is that the PN code must be at a higher bit rate than the original data. After the mixing process, the original signal takes up more space on the spectrum. This method is unconventional because traditional radio systems tried to use the least amount of spectral space per channel so that more channels could be assigned for a given bandwidth. But DSSS will allow for increase security and greater immunity to fading and multipath signals.

### Internet Protocol (IP)

Internet Protocol (IP) is regarded as an unreliable, connectionless protocol. The term “unreliable” simply means that delivery of the information packet is not guaranteed, but higher level protocols, such as TCP can provide error detection and correction which guarantees that a packet will arrive fully intact. “Connectionless” means that each packet sent does not require that a connection be made between the source and destination before the packet is sent. This enhances efficiency by not requiring any call setup. IP is used to encapsulate the higher level protocols—in this case, TCP and UDP.

Each hand unit, Clubhouse Computer, Base Station Interface and possibly printers will have a unique IP address. This will allow the system to be setup as a small network of different Local Area Networks (LAN). The LANs will be a charging LAN (RS-485), a RF LAN, and a computer LAN. The clubhouse computer and the base station interface will act as routers to the other LANs. The Clubhouse Computer will have a routing table that will be updated dynamically It will have to know when the units change from the charging to the RF LAN, or vice versa.

### Transmission Control Protocol (TCP)

Transmission Control Protocol (TCP) is a transport layer protocol that provides a connection-oriented service. It is responsible for providing a reliable connection between a source and destination and therefore is responsible for all the required handshaking, error detection and flow control. This protocol ensures that what is sent arrives to the correct destination and without any errors.

The system uses TCP to transmit information that needs to arrive to its destination and intact. All communications between the Clubhouse Computer and each charging cradle and between the Clubhouse Computer and the Base Station Interface uses TCP. The Base Station Interface is intelligent enough to determine which packets need to use TCP and which require UDP.

### User Datagram Protocol (UDP)

User Datagram Protocol (UDP) is used in situations when transmission efficiency is more important than reliability. When UDP is used, it is not crucial that the destination receives the packets intact or receives them at all.

The packets sent with UDP are not mission critical packets. They are broadcast messages and/or messages that will be sent again within a short period.

### List of TCP RF Packet Types

Food Orders

ProShop Orders

Unit position

New/Replacement Golfer data (field replacement of hand unit)

Service Request

Unit messages/memos

Unit's Scorecard

Foul Weather Updates.

### List of UDP RF Packet Types

DGPS Correction

Leader Board Updates

Regular Weather Updates

News.

### Transmission Technique

The first method of transmission is a 900 MHz FHSS system. The second method is a 2.4 GHz DSSS system. Both systems require very accurate timing to synchronize the sequencing patterns. Therefore, the microprocessor will initially get its synchronization timing from a GPS receiver. Then the microprocessor will have accurate time what is maintained and adjusted by GPS timing. The system will cover a range 3-5 Km and have a maximum output power of 1 W. Data rates are in the range of 50-100 kbps.

### Central Processing Unit

The Central Processing Unit (CPU) or microprocessor is an Hitachi SH7707 Reduced Instruction Set Computing (RISC) processor. It has an instruction set based on the C programming language. It has three power down modes: sleep mode, standby mode, and module standby mode. The chip has a 32-bit internal data bus that operates at 60 MHz and an external bus at 30 MHz. The SH7707 has an onboard serial interface for IRDA standard 1.0 and an LCD controller.

### Memory

The hand unit contains Flash Random Access Memory (RAM) and DRAM (Dynamic RAM). In the current design, there are three 512 kbytes×16 Flash RAM chips and one 4 Mbytes×16 DRAM chip.

### Charging Cradle Detection

When the hand unit is placed into a charging cradle, the charger sends a luminescent radiation pulse to the hand unit. A photosensitive transistor on the hand unit receives this pulse and wakes up the hand unit if it is in the shutdown mode. If the hand unit still had power, and therefore not in shutdown mode, the pulse has no effect. Once the cradle realizes that it is talking to a hand unit via Infrared Radiation Data Association (IRDA), the pulses of light stop, until the IRDA communications have finished.

### Infrared Radiation Data Association (IRDA) Link

The IRDA provides communications to the hand unit when it is in the charging cradle and will use the V1.0 standard. The connection uses infrared radiation as a wireless link between the charging cradle and the hand unit. This link provides for the majority if not all the updating of hand unit information. It allows for uploads of new software and images to the hand unit. The communications are done with Internet Protocol (IP) packets using both Transmission Control Protocol (TCP) and User Datagram Protocol (UDP). The packets that use TCP and UDP include the IRDA packet type used with hand unit in cradle and employ the FTP services using the IRDA for the transfer of bitmaps and the transfer of software. For uploads of relatively large files, a file transfer protocol (FTP) service will be to send the data.

### List of TCP IRDA Packet Types

Hand Unit Respond with Information

Finished Charging

Finished Updating Software

Finished Updating Bitmaps

Player Information,

### Graphical User Interface (GUI)

The communicator is interactive. A player interacts with the communicator through the GUI. The GUI organizes and displays information in a manner that requires very little effort to interpret. A player can navigate through the various screens using the keypad and menu options on the display.

### Displaying a Hole Layout

Each map for the screen will be XXX by YYY pixels and contain four sets of coordinate information. There will be two reference points surveyed on two small fixed objects for that map. These reference points will need to be taken at or near the two ends of the map. The information elements for each reference point is latitude, longitude, and altitude. The last two pieces of information are the relative offsets that the reference points have to two opposite screen corners.

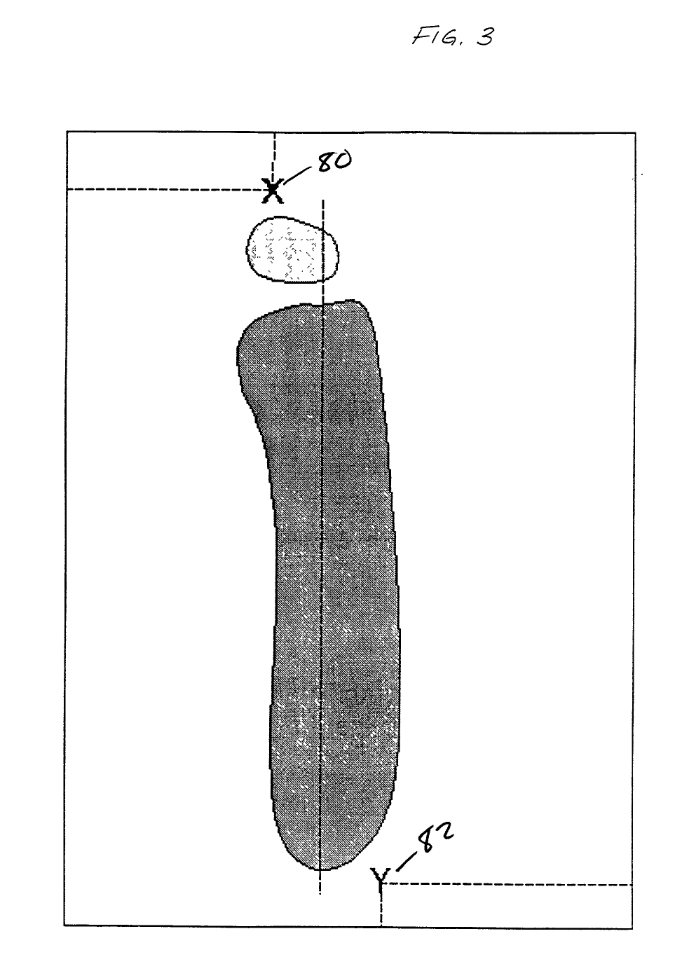

The reference points are to be surveyed based on fixed landmarks on the map or course. These landmarks should be relatively small objects that are not going to move (i.e., a sprinkler head). Ideally, the two reference points will be at the ends of the bitmap and on opposite sides of center (refer to FIG. 3). The latitude, longitude and altitude for each reference point will be stored in the unit's memory Also contained within this memory, are the reference points for all the other maps as well as at least one course reference point. This course reference point will be a point that the maps will use to position themselves with respect to the course. The course reference point will allow each map to know how it is supposed to be oriented relative to the course.

When the maps are drawn, careful attention must be taken to note the relative offset of the reference point near the top of the screen to the top left corner of the image and the relative offset of the lower reference point to the bottom right-hand corner. The person creating the bitmap can calculate this offset by placing reference points on the map and then count the number of horizontal and vertical pixels there are to the corners. This is the key link to bind the two reference frames together.

All the images will be a set size. The scale factor for a particular image can be calculated from knowing the image size and the relative offset of the reference points to the image. A greater x and y separation of the reference points on the image will give a more accurate representation of scale.

To determine the position of a play on the map, plot the actual location of the player on a reference frame with the reference points of the map. Form an imaginary line between the reference points. This is the zero angle line of the new polar coordinate system, with the bottom reference point as the center of the circle. The length between the reference points is the radius of the circle. Then draw another imaginary line between the player position and the bottom reference point. The length can be calculated using Pythagorus and the angle using trigonometry. Change the angle so that an angle of zero extends to the right of the bottom reference point (three o'clock). Now just apply the scale factor to the ray length and it can be used to plot the player on the map.

An angle of orientation for the bitmap can be calculated by taking the difference of the deltas of the two reference points relative to the course reference point. The result of this calculation will be horizontal and vertical values. Trigonometry can be used to determine the angle of rotation.

### Types of Screens on the Hand Unit

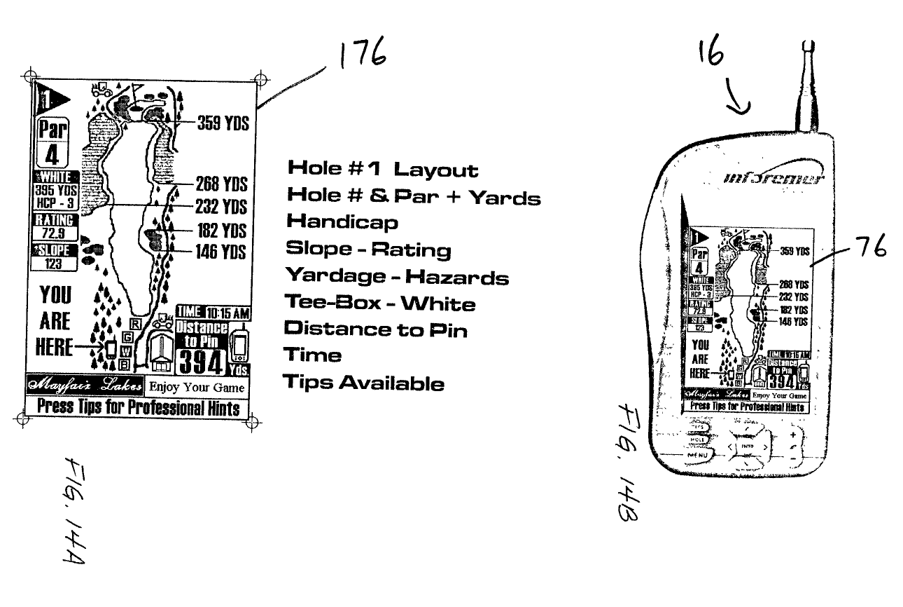

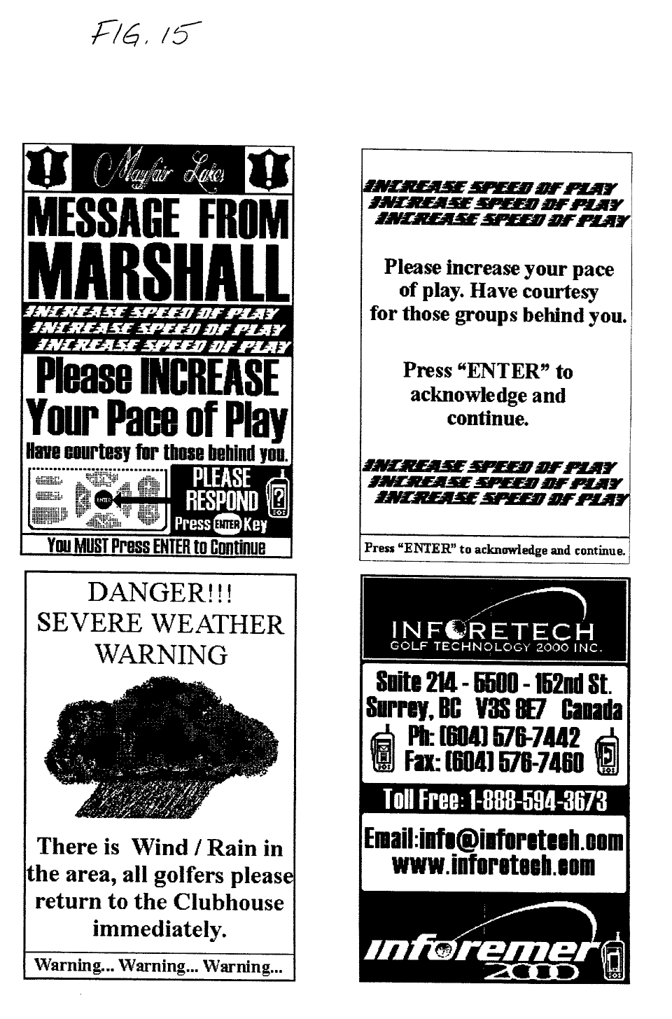

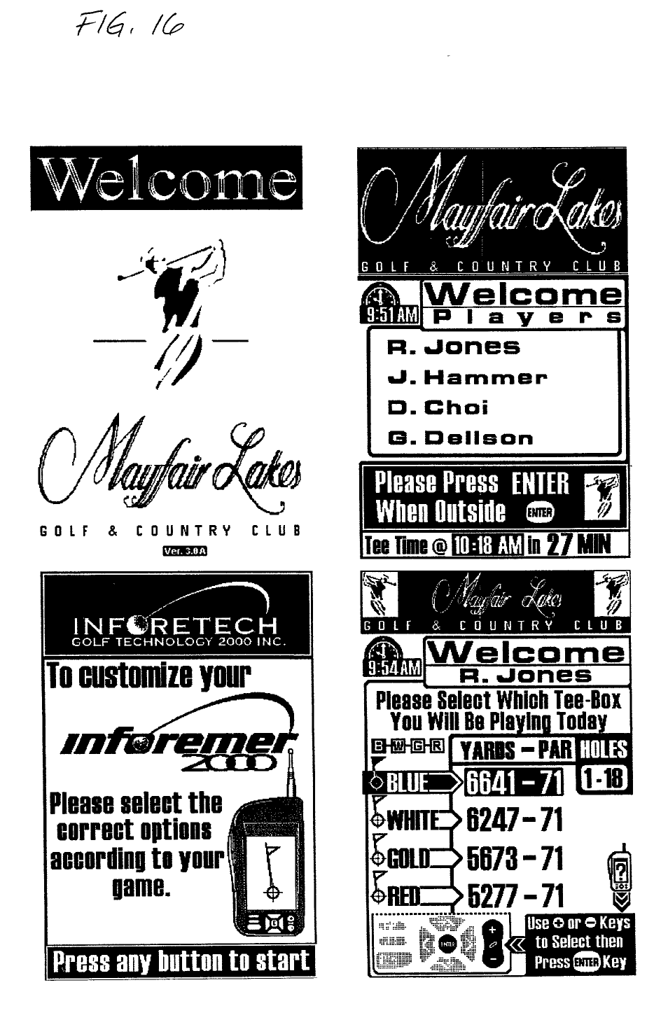

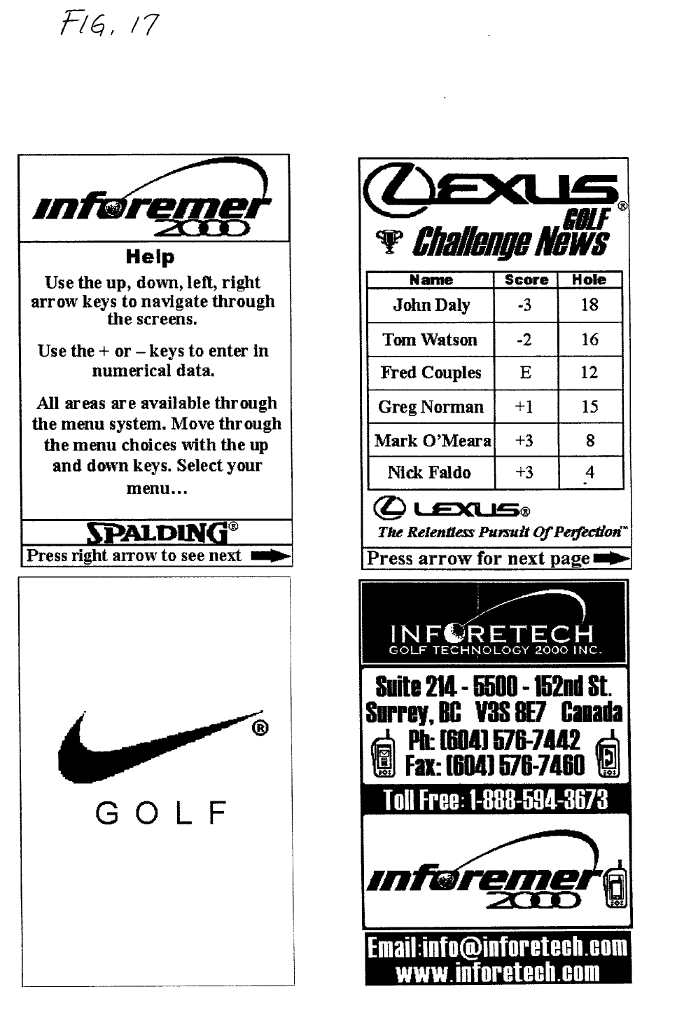

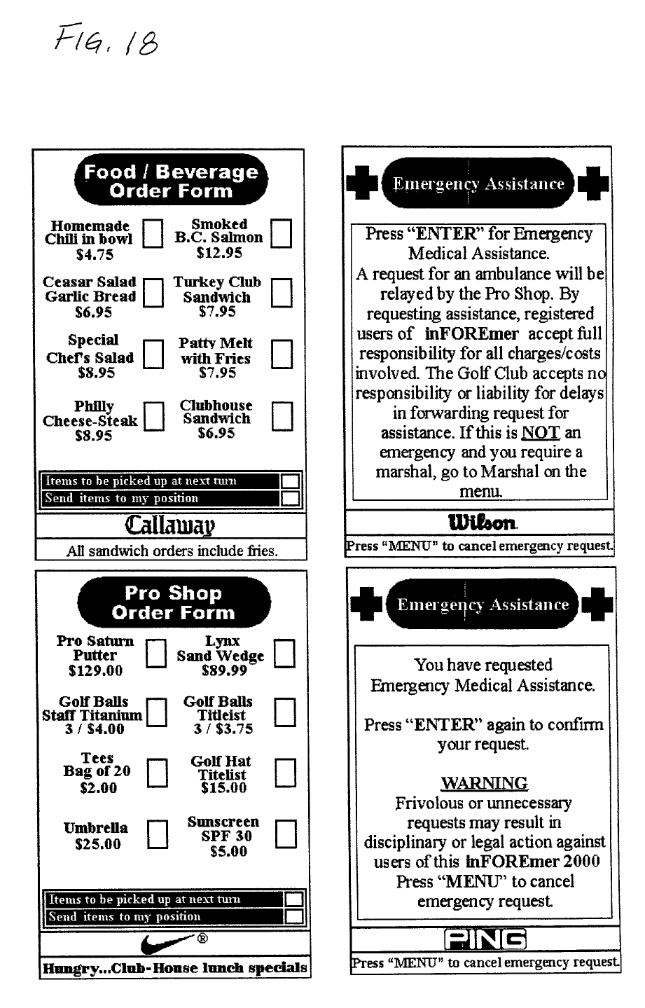

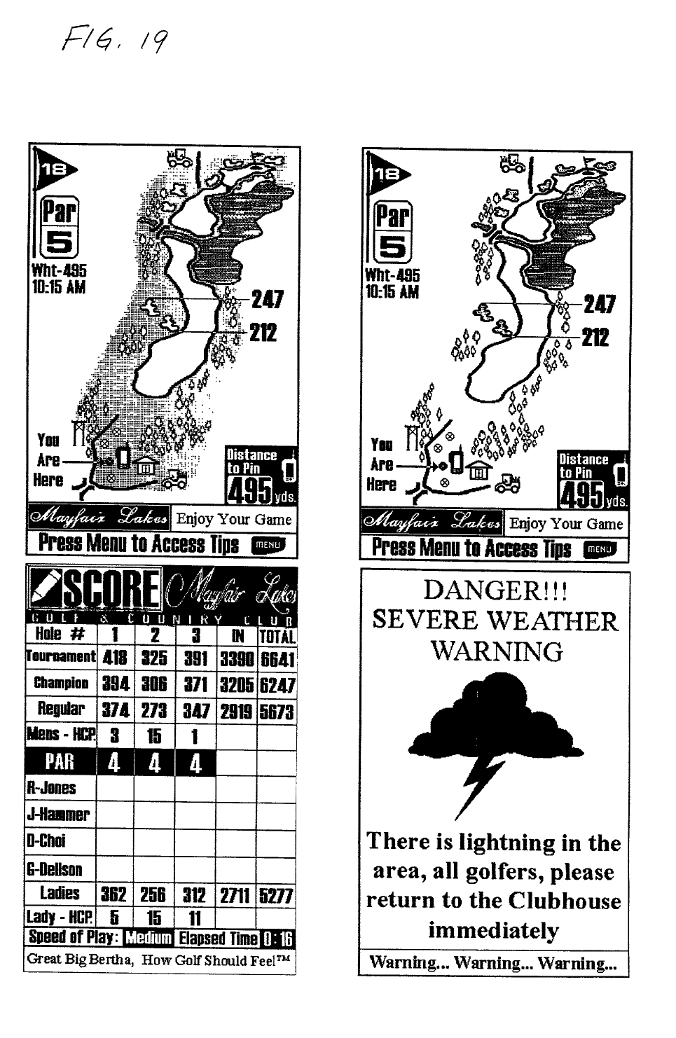

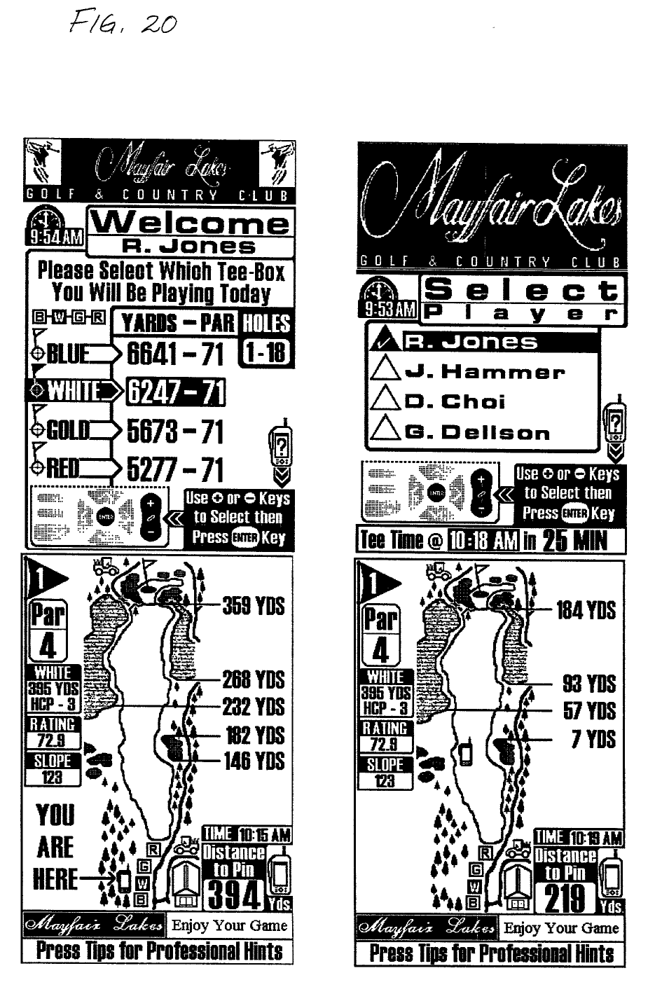

As shown in FIGS. 14A, 14B and 15-20, the hand units will be able to display a variety of screens. In FIG. 14A the bitmap graphic 176 provides a graphic display which is shown on the display 76 of the communicator 16 as shown in FIG. 14B. Additionally, several other bitmap display graphics or slides are provided for presentation, as illustrated in FIGS. 15-20 providing various messages to the user. The startup screen is a customizable message or logo. There will be at least three views per hole plus a view of the entire golf course. The first screen for a particular hole displays the entire hole.

A typical screen consists of a digitized map of the entire hole currently being played, the hole number, par of the hole, hand unit location on the map, distance to pin, distance to predefined landmarks/hazards, and an advertisement/message/memo box. The Fairway and Green screens will consist of the same information but the digitized map now displays the portion of the hole that you are currently playing.

The screens mentioned above will be displayed most of the time, but there are other screens that the user can access, which are listed below. A message screen displays a message sent to that hand unit by the clubhouse computer. Memos will scroll along the bottom of the screen. The Screens will include:

Entire Hole Display

Fairway Display

Green Display

Unit Location

Menus

Messaging

Memos

News

Weather

Scorecards

Ordering Screens

Time

Advertising

Pro Tips

Title Screen

Leader Board

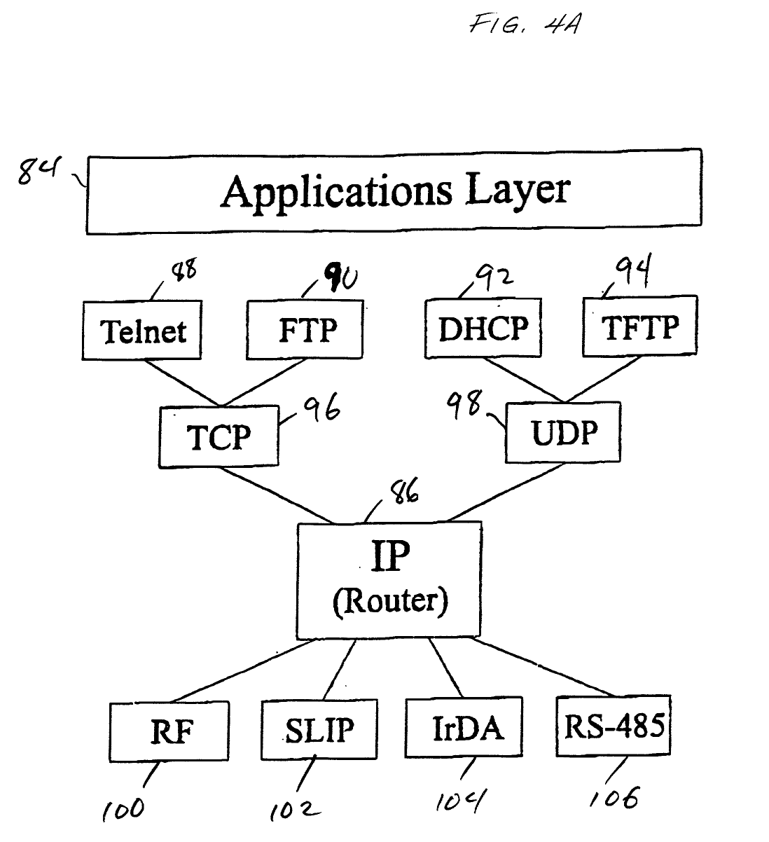

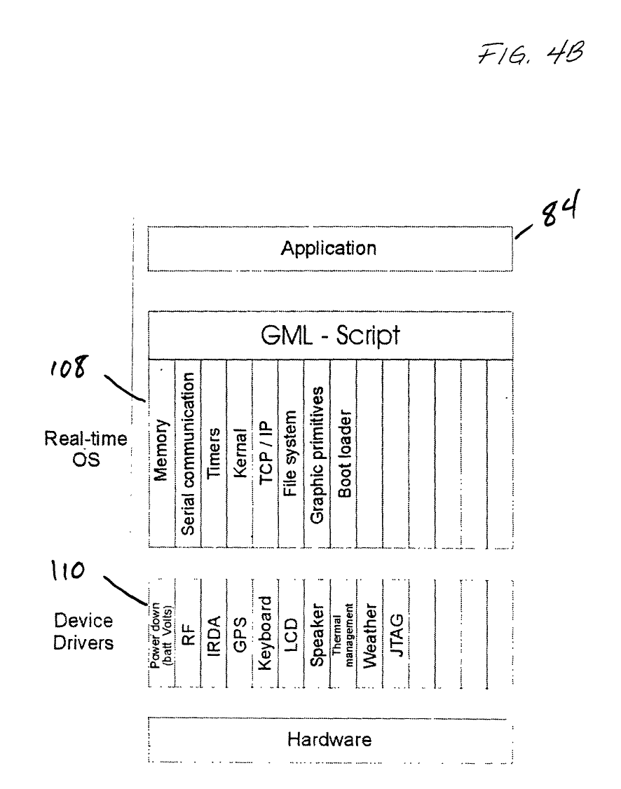

FIGS. 4A and 4B illustrate an overview of the software layers. The software is the core of a hand unit. The RISC processor runs the software to determine how and which tasks to perform. There are many layers of software that range from device drives to the application and GUI. The applications layer 84 of the software is provided as the high level user routines, which are facilitated via an internet protocol (IP) router 86 providing communications with the various hardware components of the system, as discussed herein. Telnet 88 and file transfer protocol (FTP) 90 are provided via a transmission control protocol (TCP) 96 to the IP router 86. Additionally, a Dynamic Host Configuration Protocol (DHCP) 92 and TFTP 94 for file transfer is provided via User Datagram Protocol (UDP) 98 to the IP router 86. The IP router 86 communicates with the hardware via low level routines, herein the radio frequency interface (RF) 100, the Serial Line Internet Protocol (SLIP) 102, the Infrared Data Association Protocol (IRDA) 104, and the RS-485 bus interface 106. As shown in FIG. 4B, the application layer 84 is provided above a scripting layer of the real-time operating system 108, which is provided upon bus drivers 110 for interfacing to the various described hardware components of the system The software on the hand unit is stored within the memory of the system. The software is used to display the GUI, handle RF communications, and handle background process, and performs the following software processes:

Store Information

Update Unit Location

Update Display

Calculate Distances

Monitors Trigger Locations

Monitors Local Server for New Data

Monitors User Interaction with GUI

Sends Messages to BSI

### LCD Display

The current display is a 5.75 inch (diagonal) frameless panel with 480 (w)×320 (h) pixels. The LCD is reflective monochrome with a dot size of 0.22 mm×0.22 mm and a dot spacing of 0.02 mm. The ambient temperature directly affects the contrast of the LCD, hence a contrast control circuit is used to automatically adjust the contrast. Manual contrast adjustment is available through software if required.

There are future plans to replace the monochrome LCD with a color LCD. The color display could take the form of Active Matrix (TFT), Dual Scan Twisted Neumatic (DSTN), High Performance Addressing (HPA).

### LCD Contrast Control

There are two possible circuits that can be used to adjust the contrast. They are a temperature sensor and a thermistor circuit. One control circuit will be selected based upon field testing.

The temperature sensor is a small integrated circuit (IC) that senses the temperature and assigns a corresponding output voltage. The correlation between the temperature and the output voltage is linear. The output of the temperature sensor is then amplified and then fed into the analog to digital (A/D) converter on the microprocessor. The contrast is set and regulated by the output of the digital to analog (D/A) converter on the microprocessor

The second possible circuit is a thermistor. It is a small device that gives a negative resistance coefficient with respect to temperature In normal circumstances, the resistance of a component will increase with temperature. But on a thermistor, the resistance decreases with an increase of temperature. Unlike the temperature sensor, the thermistor is not a linear device. The output of the thermistor is fed into an A/D converter on the microprocessor. The contrast is set and regulated by the output of the digital to analog (D/A) converter on the microprocessor.

### Keypad

The keypad has ten keys. Two of the keys are short cuts to frequently used screens. Four other keys are used as directional/navigational keys, and another used to select a option. There is a menu key to access the various menu options and the last two are used to increment and decrement specific fields. The keypad is made from an elastomer.

### Speaker

The speaker is a small piezoelectric buzzer. It is connected to an input/output (I/O) port of the microprocessor. When a signal is sent out of the port, the buzzer produces a noise. The frequency of the output signal to the port determines the tone of the buzzer. The output signal is set by a bit sequence from the microprocessor

Depending of the course, the buzzer can be programmed to only sound for special conditions, such as a foul weather warning Or it could be turned off completely

The hand unit can be powered by either three 1.2 Volt Nickel-metal hydride (Ni—MH) or three 4.2 Volt Lithium Manganese (Li—Mn) power cells, based on a number of factors—cost, power, mechanical constraints and availability. The batteries should allow a hand unit to run continuously for at least 12 hours before they need to be recharged. Both of these types of battery chemistries do not require extra circuitry to charge compared to Li-Ion which require Pack Control Circuitry (PCC).

The unit is 12.5 cm wide, 3.5 cm high, and 23 cm deep (not including the RF antenna). Currently there is an 8 cm long stub antenna used for RF communications. The final RF antenna length will be determine base on the type of RF technology that is implemented. The housing is a thermal plastic with an elastomer gasket around the circumference of the hand unit. On the back of the hand unit are contacts for charging and a window used for IRDA communications

The facility management processor 12, as discussed herein, has been shown in the embodiment as a personal computer (PC) which in the described embodiment is identified as a clubhouse computer (CC). The facility management processor 12 is database driven providing a scripting language for providing the database communications to the various other aspects of the system. An overall structure of the programming is as follows:

### Main Menu

→Database

→Update Course Info

→Update Player Info

→New Player

→Print Score Card

→Reports

→User Report 1

→User Report 2

→User Report 3

→Display

→Zoom In

→Zoom Out

→Select Zone

→Management

→Broadcast Message

→Locate Player

→Attach Flag

→Clear APT

→Pace of Play

→User

→Course

→Warning Messages (enable/disable)

→Hand Unit

→Download

→Locate

→Send Message

### Clubhouse Computer

The Clubhouse Computer (CC) is made up of seven sections:

1. GUI

2. Background Software

3. Database

4. RS-485 Communications

5. RS-232/Fiber Optic Communications

6. UPS Backup

7. Printer.

The CC is a recommended to be an Intel PII-233 MHz personal computer with 32 MB of RAM. The CC can be configured in a number of configurations.

The main operating system that the golf course management system runs on is Linux. Linux is a derivative of UNIX. It was developed in the early 1990's as an alternative operating system for the xx86 base personal computer. It has the look and feel of UNIX but is freely distributed with all source code available. Linux is a pre-emptive multitasking operating system designed to be used in a network. Linux uses a windowing system called X Windows System to provide a Graphical User Interface (GUI).

The CC may be programmed with a scripting language called Tool Command Language/Tool-Kit (Tcl/Tk). It is a high-level language that allows for relatively fast software development. After the CC boots, the golf course management system program automatically loads. When the main program is running, it will take up the entire screen and will not allow the user access to any Linux function or to exit the program unless a password is provided.

There is a database of statistics about the system and players. This data base will allow columns to be added to existing tables and allow multiple queries at the same time.

The CC may be connected to various communication devices via the computer's communication ports and a Network Interface Card (NIC). These communication devices will be a modem, UPS battery backup, RS-485 bus, and RS-232/fiber optic cable.

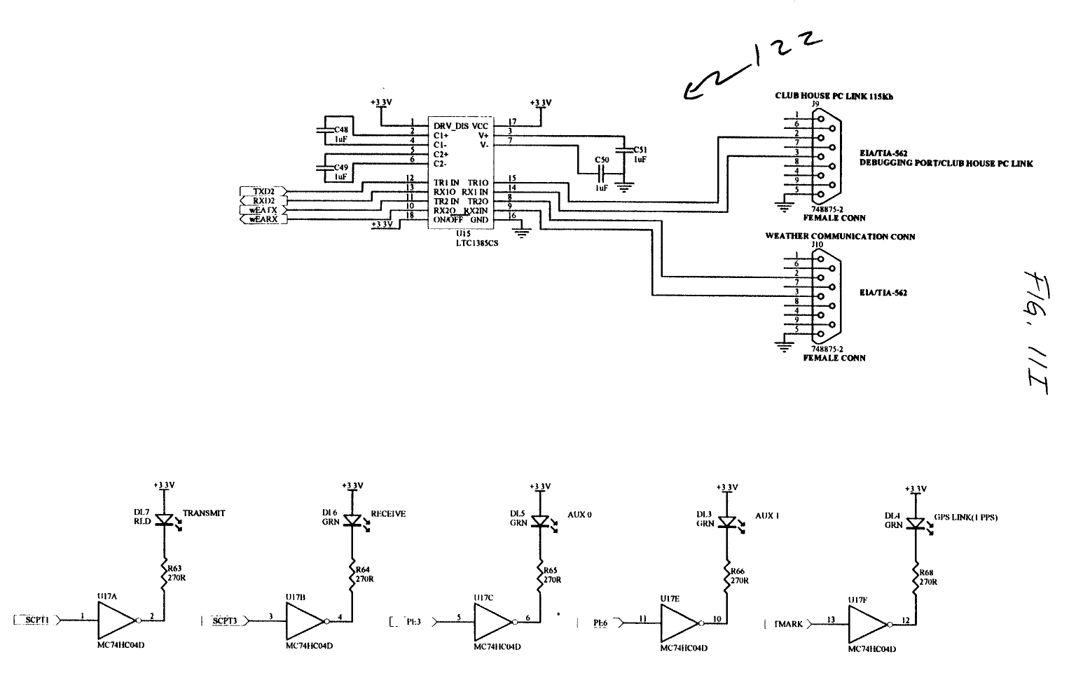

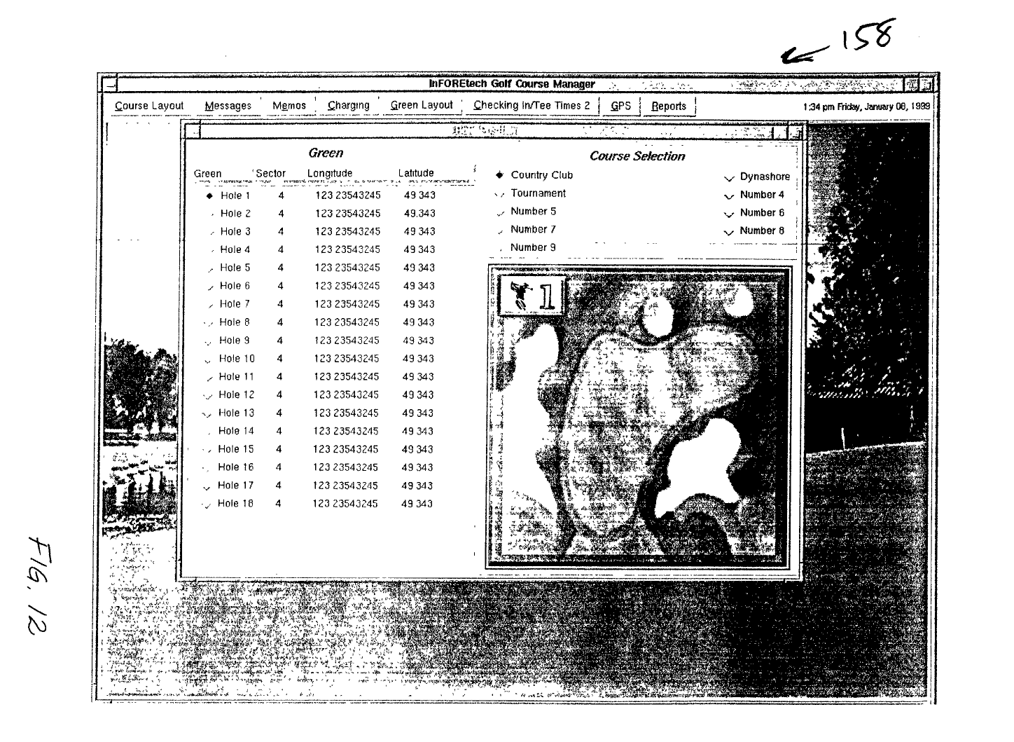

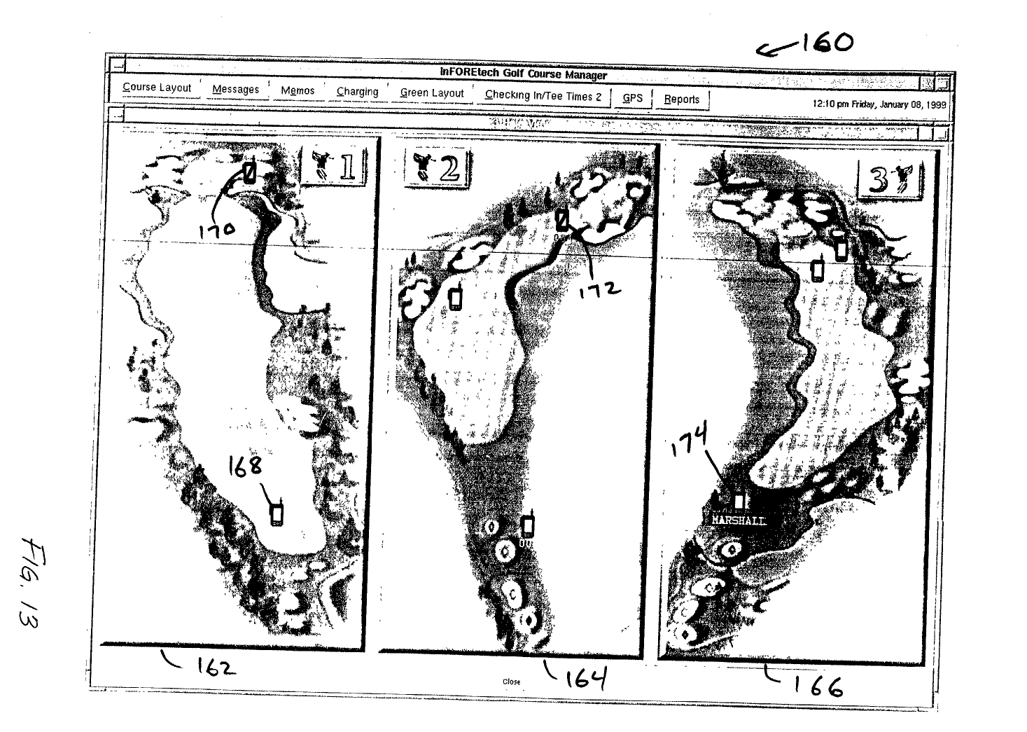

The Graphical User Interface (GUI) is how users will interact with the application program. FIG. 12 illustrates the personal computer display screen associated with the facility management processor. FIG. 13 shows the personal computer display on the facility management computer illustrating a three-hole view in the described golf course embodiment. A personal computer screen 158 shows the course selection menu of the golf course manager program used in setting up the longitude and latitude positions of the holes associated with the selected golf course. In FIG. 13, the personal computer screen 160 is broken in three parts, those of screens 162, 164, and 166 which show the first, second, and third holes of the golf course respectively in a three-hole view using the golf course manager program on the CC facility management processor personal computer. Herein, the communicator units are shown as several icon symbols throughout the golf course, allowing golf course management to visually observe the positioning and course of play of individuals on the illustrated golf course in the screen display 160. For example, communicator icons 168, 170, 172, and 174 may be used for signaling to the clubhouse manager, information relating to the users. More specifically, the display area may be shown in color, e.g., red, yellow, green, to indicate the user's conduct of play and the like. For example, a red display on the icon may indicate that the user is playing the course too slowly, while a green display indicates proper game play. As illustrated in the drawings, icons 170 and 172 show a hash mark across the display which may indicate a display other than a color display for the purpose of illustration. Additionally, the identification number of the associated communicator is identified along with the communicator icon, and further information such as the marshall descriptor as shown with icon 174 illustrates a golf course official in possession of the communicator. Accordingly, the screen display 160 provides a unique view for observing the users of the golf course as game play proceeds, allowing for facility management of the recreational area. The application will contain many types of screens which are listed below.

Main Title Screen

Course Layout

9 Hole Zoom

3 Hole Zoom

1 Hole Zoom

Messaging

Memos

Charging Status

Green Layout

Tee Time Bookings

Scorecards

Weather

Cart Info

Rules

Advertising

Food Menu

Proshop Menu

Course Maintenance

System Maintenance

Tournaments

Play Times

Summary Info

Etc.

### Background Processes

While the user interacts with the GUI layer, many background processes are running to maintain, inform and update the system. There is a server that constantly monitors for new data or requests. If data needs to be sent outs a client is created to a particular IP address. The charging cradles are monitored for hand units that have just been place or removed. They are also monitored to charge status to determine which hand units are ready to be use again. All this information that is gathered by the system must be sorted and then stored into database tables. The GUI must get location information from the hand units so that it can be displayed on the screen in virtually real time.

The CC monitors every hand unit's pace of play to determine if there are any slow areas. It also monitors the UPS to see if a power failure has occurred. A leader board for all tournaments being played at a certain time must be maintained and periodically transmitted to field hand units. A list of background processes on the CC is as follows:

Monitors server for new data

Monitors for new data to be sent

Monitors charge status of charging hand units

Monitors UPS

Monitors user interaction with GUI

Monitors pace of play

Updates GUI display

Updates hand unit locations

Updates leader boards

Update database tables

Sends orders to kitchen printer

Sends score card information to proshop printer.

### Database

The database will be able to handle large amounts of data. It will be a relational database and should be able to handle most if not all the Structured Query Language (SQL) specifications. Another important feature of the database is its ability to alter tables. This means that an existing table can have columns added to or deleted from. With this feature, it will be easy to modify the database to suite the needs of a particular customer or even change with different trends. The database will also handle multithreading. Multi-threading allows multiple queries to occur at the same time.

Every relational database table contains a key. The key is a column or set of columns that organize the table. On a one column key every entry in the key column must be unique.

Currently there are eight defined data structures:

General Information

Member Information

Unit Information

Map Information

Daily Usage Information

Orders Information

Bookings

Service Requests.

### General Information

This table is used to keep records of members at a particular golf course.

| | | | | | | | | | |
|---|---|---|---|---|---|---|---|---|---|
| Member | First | Middle | Last | | | Email | Home | Business | |
| # | Name | Name | Name | Age | Sex | Address | Phone | Phone | Handicap |

The general information database will be a single table that contain the above information about each user unique to every entry.

### Member Information

This table is used to track information for a particular member. Each member should have their own table of information.

| | | | | | | | | | | | | S | S | S | S | S | S | S | S | S | | |
|---|---|---|---|---|---|---|---|---|---|---|---|---|---|---|---|---|---|---|---|---|---|---|
| | | | S | S | S | S | S | S | S | S | S | c | c | c | c | c | c | c | c | c | | |
| | | | c | c | c | c | c | c | c | c | c | o | o | o | o | o | o | o | o | o | | |
| | | | o | o | o | o | o | o | o | o | o | r | r | r | r | r | r | r | r | r | S | |
| | | | r | r | r | r | r | r | r | r | r | e | e | e | e | e | e | e | e | e | t | |
| | | | e | e | e | e | e | e | e | e | e | | | | | | | | | | a | E |
| | | | | | | | | | | | | H | H | H | H | H | H | H | H | H | r | n |
| | | C | H | H | H | H | H | H | H | H | H | o | o | o | o | o | o | o | o | o | t | d |
| | | o | o | o | o | o | o | o | o | o | l | l | l | l | l | l | l | l | l | l | | |
| D | U | u | l | l | l | l | l | l | l | l | l | e | e | e | e | e | e | e | e | e | T | T |
| a | n | r | e | e | e | e | e | e | e | e | e | | | | | | | | | | i | i |
| t | i | s | | | | | | | | | | 1 | 1 | 1 | 1 | 1 | 1 | 1 | 1 | 1 | m | m |
| e | t | e | 1 | 2 | 3 | 4 | 5 | 6 | 7 | 8 | 9 | 0 | 1 | 2 | 3 | 4 | 5 | 6 | 7 | 8 | e | e |

There will be a member information table for each member at the golf course. It will keep track of every round of golf played at this club along with the course that was played (for clubs with multiple courses). The key to this table is the Date and Start time.

### Unit Information

This table is used by the clubhouse computer to determine the status of all the hand units.

| | | | | | | | | | |
|---|---|---|---|---|---|---|---|---|---|
| Unit | IP | Field of | | | | Charge | Unit | Software | Bitmap |
| # | Address | Charging | Latitude | Longitude | Altitude | Status | Status | Ver. | Ver. |

This table provides all the vital information about a particular hand unit. Every unit at the golf course will have its own entry in this table with the key to the Unit Information table being the IP address of the unit.

### Map Information

This table provides all the vital information about a particular map.

| | | | | | | | | | | | |
|---|---|---|---|---|---|---|---|---|---|---|---|
| Map | | Ref 1 | Ref 1 | Ref 1 | Ref 1 X | Ref 1 Y | Ref 2 | Ref 2 | Ref 2 | Ref 2X | Ref 2 Y |
| Name | Sector | Lat. | Long. | Altitude | Offset | Offset | Lat. | Long. | Attitude | Offset | Offset |

This table is dependent on the mapping technology that is chosen to map and survey a course. Currently, the unique column is the Map Name column.

### Daily Information

This is information that can be used to see how players used the system and other general course information.

| | | | | | | | |
|---|---|---|---|---|---|---|---|
| Unit | Member | | Total | Start | End | # Items | # Messages |
| # | # | Course | Score | Time | Time | Ordered | Rx. |

This table a central data base of general information about the golf course usage with the golf course management system. The Member # and Start Time columns are unique if a new table is generate for each day.

### Order Information

This table is used to record when, who and how much is ordered by players This is just one of many possible tables that keep track of usage.

| | | | | | |
|---|---|---|---|---|---|
| Unit # | Member # | Date | Time | Item | Quantity |

The keys are the Time and Date. These two columns will provide enough information to allow queries about a certain, item, member or date

### Booking Information

This table keeps track of bookings for a certain day. There will be a new table for each day.

| | | | | | | | |
|---|---|---|---|---|---|---|---|
| Tee | | Member | First | Middle | Last | Unit | |
| Time | Course | # | Name | Name | Name | Assigned | Paid |

A new table is generated for each date that bookings can be made. The key field is the Tee Time field.

### Service Information

The Service Information table records instances of when a player requested service. This could be a request for the ranger to an emergency.

| | | | | |
|---|---|---|---|---|
| Unit # | Member # | Date | Time | Type of Service |

This table will allow administrators to keep track of the type of service request and who make them. This keys to this table are the Date and Time columns.

### RS-485 Communications

The Clubhouse Computer (CC) communicates with the charging cradles through an RS-485 connection. The golf course management system implementation of RS-485 uses a differential two wire bus. It allows numerous connections on the bus, therefore allowing many charging stations to be connected to the CC. The RS-485 is able to span distances of a few hundred meters. Thus allowing the charging cradles to be located a significant distance away from the CC.

Each charging cradle will be given its own IP address so that the clubhouse computer can talk to each charging cradle individually. The communications on the bus uses IP packets with the TCP protocol. The bus is half-duplex, which means that only one address can talk at any given time. The types of TCP packets on the RS-485 bus, including the following:

Charge Status

Hand Unit in Cradle #

FTP Information Transfers

New Player Information

More Packets to be defined . . .

### RS-232/Fiber Optic Communications

The Base Station Interface (BSI) connection to the Clubhouse Computer (CC) uses RS-232. It is a full-duplex communications medium. The RS-232 from the CC goes into an RS-232 to fiber optic converter, where the RS-232 signals are translated into signals that can be transmitted into a fiber optic cable. At the other end of the fiber optic cable is a second converter to convert the signals back to RS-232. The RS-232 connection uses IP packets with the TCP protocol. A list of packets that are sent with between the BSI and the CC are listed below. The fiber optic cable allows for two important features.

The first is to electrically isolate the RF antenna, GPS antenna, and BSI from the rest of the system. If lightning is to strike, it is most likely to hit one of the antennas. The fiber optic cable is not electrically conductive and will not pass a power surge to the CC or the other parts of the system. Second is the ability to place the BSI any distance away from the CC without suffering any significant signal attenuation.

### List of TCP Packets on the RS-232/Fiber Optic Connection

Sending Messages/Memos

Leader Board Updates

New Player Information

Unit Location

Pace of Play Messages

Orders

Current Player Scores

New Cup Location

More Packets to be defined . . .

The UPS backup on the Clubhouse Computer (CC) has two functions. The first is to monitor the AC power to detect for power failures. When a power failure is detected, the UPS sends a signal through one of the CC's communication ports. Then the UPS software combined with the CC software starts an orderly shutdown of the CC. It starts by saving all vital information and then logs out of the Linux operating system.

The second function is to clean the AC power of surges, spikes and brown outs. Unclean power is a major cause of computer malfunctions. Implementing the UPS should reduce field service call and improve system reliability.

Printers will be integrated into the system to meet the needs of the golf course. There could be any number of printer connected to the system and they could be located anywhere in the clubhouse or attached building.

If only one or two printers are needed and they are located within 50 feet of the Clubhouse computer, normal printer connections and cable can be used. If more than two printers are required and/or the printers are located far from the Clubhouse computer, network printers must be used with networking cables run to each printer.

The Base Station Interface (BSI) is made up of five sections:

1. GPS

2. DGPS Calculations

3. RF Transceiver

4. RS-232/Fiber Optic Communications

5. Power Supply.

The BSI has its own IP address and acts as a gateway between the hand units in the field and the Clubhouse Computer (CC). All communications between the CC and the BSI is done using the TCP protocol, but not all packets that are sent from the BSI to the hand units use TCP, such as a promotional advertisement or a leader board update. Therefore the BSI must be able to convert a TCP message to a UDP message before it is sent on the RF transceiver. The BSI is also responsible for transmitting information that is not provided by the CC, for example, DGPS corrections, and weather updates. The BSI has a communications port that will accept weather information from a separate weather module and another to communicate with the CC. Refer to FIG. 5 for a block diagram of the BSI.

The BSI will have a server open to allow the CC and the hand units to communicate with it. It will have to create a new client to a particular IP if it wants to talk to that IP address. After the message is sent, the client will close so that it will not send continually send packets telling the server that the client is still connected. Otherwise, this would take up valuable bandwidth.

The BSI has its own GPS receiver and a high gain RF antenna. The RF antenna is used to receive and transmit information to and from the hand units in the field. The GPS receiver is used to calculate the correction factor for DGPS.

The GPS receiver at the BSI is used to find the real time correction factor for the DGPS. The GPS antenna will know its position on the earth from either being surveyed or an average of GPS readings taken over a period of time. It is very important to have an accurate position reading for the GPS receiving antenna. The correction factor is base on that position. After the fixed GPS position has been determined, a correction factor can be calculated using a method called pseudo ranging correction

The GPS receiver is a Rockwell Jupiter module, and is the same unit used in the hand units. There are two differences about this module compared to the hand units. First, this receiver is fixed and does not move and second, a correction factor is not applied to the GPS readings.

The correction factor based on DGPS is calculated using a method called pseudo range correction. Basically, the correction factor is calculated by finding the difference of the apparent fixed GPS location to the actual fixed location. An alternative method called delta correction could also be used. The delta correction method is more precise. Delta correction uses the raw data directly received from the orbiting satellites for its calculation of the correction factor. It accounts for the number of satellites in view and the signal change with respect to time.

The correction factor is calculated continually and formatted as an RTCM SC-104 message. It is sent out on the RF transceiver as a UDP broadcast packet at certain intervals. As more correction factor packets get sent out, the accuracy of the position of the hand units is increased.

The RF transceiver is used as the communications medium between the BSI and the hand units in the field. The BSI and the hand units all have a unique IP address. Communications from the BSI and the hand units can be both TCP and UDP, while communications from the hand units to the BSI use only TCP.

The BSI takes a low AC voltage as its power source. The low AC voltage is generated from a power supply, which runs off a line of 120/240 VAC. It converts the high AC voltage to a 12 VDC.

### Charging Cradle

The Charging Cradle is made up of three sections:

1. Power Supply

2. RS-485 Communications

3. IRDA Communications.

Each charging cradle will have its own IP address and intelligence. The charger will be able to detect when a hand unit is placed or removed. It will then convey this information back to the CC. The cradle will be able to turn on a hand unit if it was in the shutdown mode. Once the cradle and the hand unit start talking, the hand unit can be interrogated to determine the hand unit's IP address, its software version and bitmap version. When the cradle receives this information, the cradle can decide if there is any updates that need to be down loaded to the hand unit. Refer to FIG. 6 for a block diagram of the charging cradle.

If there is new information for the cradle to upload to the hand unit, an FTP service will be setup to complete the transfer of data. When all updates are complete, the cradle will revert back to its default state of polling to see if a hand unit is in the cradle.

When a player has checked in at the proshop, a new player information message is sent from the CC to a charging cradle with a hand unit that is ready to be used. The message will generate a new game on the hand unit with the player name(s) on already inputted on the hand unit.

If a hand unit is taken out of the cradle before all the necessary information has been downloaded to the hand unit, the RF channel can resume the data transfer to complete the download.

The mechanism used to hold the hand unit onto the charging cradle is based on Cypress Solutions patent number.

The current power supply for the charging cradles is a transformer that outputs a low AC voltage. The charging cradles have a power circuit to rectify and convert the low AC input voltage into a usable form.

### Communication Packets

The Communication Packets is made up of sections:

1. Between Charging Cradle and Hand Unit

2. Between Charging Cradle and Clubhouse Computer

3. Between Base Station Interface and Clubhouse Computer.

### (1) Between Charging Cradle and Hand Unit Respond if Hand Unit in Cradle

In the default state, each charging cradle is constantly polling to see if a hand unit has been place there. Also, after the hand unit has been fully serviced, the charger reverts back to its default state and start polling continuously. The only information item in this packet is the charging cradle's IP address.

Direction: Charge cradle→Hand unit

Type of Protocol: UDP

Packet Format: respond_hu chgno_xxx.xxx.xxx.xxx

### Respond with Information

Once a hand unit receives an “Are you there?” packet, the hand unit will reply with information store in memory. The first item is the number of times that the unit has been recharged since its last condition cycle. Second is the bitmap version number and next is the software version number. All three of these three digit numbers will wrap around to “000” if the numbers go above “999”. The last set bit of information is the hand unit's IP address.

| | |
|---|---|
| Direction | Hand unit → Charge cradle |
| Type of Protocol | TCP |
| Packet Format | answer recharge_xxx bmpver_xxx |
| | swver_xxx huno_xxx.xxx.xxx.xxx |

### Finished Charging

When the charging cradle senses that the charging cycle is complete, it will send this packet to the hand unit. The function of this packet is to let the hand unit know the recharge number. The charging cradle sets the recharge number and not the hand unit. The hand unit only stores this information for the next time this value is requested.

| | |
|---|---|
| Direction | Charge cradle → Hand unit |
| Type of Protocol | TCP |
| Packet Format | done_charge recharge_xxx |

### Finished Updating Software

This is to tell the hand unit that FTP services for uploading the new software version have been completed. It also tells the hand unit the new software number to be stored in the hand unit's memory.

| | |
|---|---|
| Direction | Charge cradle → Hand unit |
| Type of Protocol | TCP |
| Packet Format | done_ftp_sw swver_xxx |

### Finished Updating Bitmaps

This is to tell the hand unit that FTP services for uploading the new bitmaps have been completed. It also tells the hand unit the new bitmap number to be stored in the hand unit's memory.

| | |
|---|---|
| Direction | Charge cradle → Hand unit |
| Type of Protocol | TCP |
| Packet Format | done_ftp_bmp bmpver_xxx |

### (2) Between Charging Cradle and Clubhouse Computer Tell CC That Unit is Ready to Accept Player Data (Interim)

This is an interim packet for testing purposes. It is used to tell the CC of a unit that is ready to accept player information data.

| | |
|---|---|
| Direction | Charge cradle → CC |
| Type of Protocol | TCP |
| Packet Format | oncharge day_dd mon_mm yr_yyyy |
| | sec_ss min_mm hr_hh unit_xxx |

### Give Player Data to Charging Cradle

This packet is invoked from the Tee Time/Booking screen. A packet is sent for each player for a given tee time. This info is sent directly to the charging cradle with the hand unit number in the packet. The player's name is split into it's three components. If no middle name is given, you will see “. . . middle_. . . ”. Player is the order that the players were entered into the bookings screen. Start is the hole that the group is to start at.

| | |
|---|---|
| Direction | CC → Charge cradle |
| Type of Protocol | TCP |
| Packet Format | player_info day_dd mon_mm yr_yyyy |
| | sec_ss min_mm hr_hh unit_xxx |
| | player_x first_xxxxx middle_xxxxx |
| | last_xxxxx start_x |

### (3) Between Base Station Interface and Clubhouse Computer Tell CC That Unit is in the Field (Interim)

This is an interim packet for testing purposes. It is used to tell the CC of a unit that is currently on the RF link.

| | |
|---|---|
| Direction | BSI → CC |
| Type of Protocol | TCP |
| Packet Format | onrflink day_dd mon_mm yr_yyyy |
| | sec_ss min_mm hr_hh unit_xxx |

### Gives the CC GPS Coordinates in Long. Lat. Elevation Form (Interim)

This packet gives the CC GPS coordinates in the Long. Lat. Elevation format.

| | |
|---|---|
| Direction | BSI → CC |
| Type of Protocol | TCP |
| Packet Format | gpscoordslle day_dd mon_mm |
| | yr_yyyy sec_ss min_mm hr_hh |
| | unit_xxx long_xxx lat_xxx |
| | elev_xxx tc_xxxx |

### Gives the CC Diagnostic GPS Coordinates in Long. Lat. Elevation Form (Interim)

This packet gives the CC in-depth GPS coordinates in the Long. Lat. Elevation format. The italic portion's length is variable based on the number of satellites in site.

| | |
|---|---|
| Direction | BSI → CC |
| Type of Protocol | TCP |
| Packet Format | gpsdiaglle day_dd mon_mm yr_yyyy |
| | sec_ss min_mm hr_hh unit_xxx |
| | long_xxx lat_xxx elev_xxx |
| | #stat_xx sat1_xx az1_xxxxx |
| | el1_xxxxx sat2_xx az2_xxxxx |
| | el2_xxxxx . . . tc_xxxx |

### Gives the CC GPS Coordinates in UTM-83 Form (Interim)

This packet gives the CC GPS coordinates in the UTM-83 format. This will probably change when we know more about the UTM format.

| | |
|---|---|
| Direction | BSI → CC |
| Type of Protocol | TCP |
| Packet Format | gpscoordsutm day_dd mon_mm |
| | yr_yyyy sec_ss min_mm hr_hh |
| | unit_xxx x_xxx y_xxx tc_xxxx |

### Gives the CC Diagnostic GPS Coordinates in UTM-83 Form (Interim)

This packet gives the CC in-depth GPS coordinates in the UTM-83 format. The italic portion's length is variable based on the number of satellites in site. This will probably change when we know more about the UTM format.

| | |
|---|---|
| Direction | BSI → CC |
| Type of Protocol | TCP |
| Packet Format | gpsdiaglle day_dd mon_mm yr_yyyy |
| | sec_ss min_mm hr_hh unit_xxx |
| | x_xxx y_xxx #stat_xx sat1_xx |
| | az1_xxxxx el1_xxxxx sat2_xx |
| | az2_xxxxx el2_xxxxx . . . tc_xxxx |

### Memo

This is the memo packet. The data is the text message that will be displayed on the hand unit. The spaces in the text messages may be replace with “_”.

| | |
|---|---|
| Direction | CC → BSI |
| Type of Protocol | TCP |
| Packet Format | memo day_dd mon_mm yr_yyyy sec_ss |
| | min_mm hr_hh unit_xxx data |

### Message

This is the memo packet. The data is the text message that will be displayed on the hand unit. The spaces in the text messages may be replace with “_”.

| | |
|---|---|
| Direction | CC → BSI |
| Type of Protocol | TCP |
| Packet Format | message day_dd mon_mm yr_yyyy |
| | sec_ss min_mm hr_hh unit_xxx data |

### The Network Server

The Server is made up of 2 sections:

1. Internet connection

2. Modem.

There are future plans to allow every golf course management system to connect to a central server through the Internet. It would allow the server to download special information to a particular golf course management system or upload player information or other statistics from the golf course.

When the server is fully functional, players will be able to log onto the server and see their scores at various courses that they played which had the golf course management system installed.

Each golf course management system will be protected by a firewall. A firewall is a device that monitors incoming and outgoing packets from the Internet into a network. It helps minimize damage that may be done by hackers.

The connection to the Internet or the server can be made using a dial-up modem. Linux does not support modems that are specifically made for Windows operating system. These types of modems often referred to as “winmodems” have no onboard intelligence.

Modems from a major manufacture that are not specifically designed for Windows will not be a problem.

With the CC connected to an LAN other computers at the golf course will be able to Telnet and FTP into the CC. This will allow other computers access to files and databases on the CC provided that proper permissions are set.

A separate module can be used to collect weather information. The information gathered will then be passed to the weather port of the Base Station Interface. Types of weather information that could be gathered are:

Wind Speed and Direction

Temperature

Humidity

Rain counter

Ultra Violet Meter

Barometer.

While there has been illustrated and described particular embodiments of recreational facility management systems, it will be appreciated that numerous changes and modifications of the invention will occur to those skilled in the art, and therefore it is intended that the appended claims cover all changes and modifications which fall within the true spirit and scope of the invention.

What is claimed is:

1. A recreational facility management system for monitoring users within a plurality of predefined areas of the facility for generating usage information, comprising:
a monitoring network;
a facility management processor coupled to said monitoring network;
a multiplicity of hand-held communicators;
a transmission link for transferring information from said facility management processor to said hand-held communicators for sending information relating to the plurality of predefined areas to said hand-held communicators;
a base station interface coupled to said monitoring network;
a first base station global positioning system (GPS) receiver associated with said base station;
a multiplicity of second communicator GPS receivers, one each associated with each of said hand-held communicators;
a first base station radio frequency (RF) transceiver associated with said base station;
a multiplicity of second communicator RF transceivers, one each associated with each of said hand-held communicators; and
a multiplicity of communicator processors, one each associated with each of said hand-held communicators for processing the communicator GPS data received via said second communicator GPS receivers, base station GPS data received via said second RF transceivers, and information relating to the plurality of predefined areas for communicating usage information relating to the plurality of predefined areas of the facility to the users.

2. A system as recited in claim 1 wherein said hand-held communicators each comprise an electronic display for displaying information relating to the plurality of predefined areas of the facility in a graphic format.

3. A system as recited in claim 2 wherein each of said communicators comprise a programmable memory for storing bitmap images communicated to said communicators via said transmission link for display on said electronic display.

4. A system as recited in claim 3 wherein said memory stores a bitmap slide show employing a script program provided by said facility management processor.

5. A system as recited in claim 1 wherein said hand-held communicators comprise a FLASH programmable program memory employing a boot loader facilitating program updates from said facility management processor via said transmission link.

6. A system as recited in claim 5 comprising a multiplicity of charging cradles, one each associated with each of said hand-held communicators, said transmission link being coupled to the charging cradle, allowing updating of communicator memory while said communicators are being recharged in the charging cradle.

7. A system as recited in claim 6 wherein said transmission link comprises an Infrared Data Association (IRDA) implementing the high-level data-link control (HDLC) communication protocol for standard infrared data transmission via said transmission link.

8. A system as recited in claim 6 wherein said transmission link implements Transmission Control Protocol/Internet Protocol (TCP/IP) as a networking protocol providing communication across said data transmission link and said monitoring network using said facility management processor.

9. A system as recited in claim 1 wherein said base station interface comprises an uninterruptible power supply (UPS) allowing use of said communicators as fault tolerant with respect to said facility management processor.

10. A system as recited in claim 1 comprising one or more weather monitors coupled to said base station interface.

11. A system as recited in claim 1 wherein said facility management processor communicates with said hand-held communicators via said first base station RF transceiver.

12. A system as recited in claim 11 wherein said facility management processor comprises a personal computer providing a graphical display thereon for monitoring the progress of the users of the facility within predefined areas, providing communication broadcasts to the users over said communicators and providing service and health information via said communicators.

13. A system as recited in claim 12 comprising a server for communicating with said personal computer via a network connection providing remote graphical update and program information to said personal computer and said communicators.

14. A system as recited as in claim 13 wherein said network connection between said personal computer and said server comprises an internet connection.

15. A system as recited in claim 2 wherein said communicators comprise a digital compass for providing geographic orientation information to the users.

16. A system as recited in claim 15 wherein said electronic display provides touch screen soft key interaction with the users.

17. A system as recited in claim 16 wherein said recreational facility comprises a golf course.

18. A system as recited in claim 16 wherein said recreational facility comprises a natural outdoor setting such as a park for hiking, skiing, or other outdoor activities carried out within predefined areas of the recreational facility.

19. A method of managing a recreational facility, comprising the steps of:
monitoring users of the recreational facility within a plurality of predetermined areas;
generating usage information relating to the monitoring of the users within the plurality of predefined areas;
processing the usage information via a monitoring network;
providing a multiplicity of hand-held communicators;
transferring information generated from said processing step to the hand-held communicators for sending information relating to the plurality of predefined areas to the hand-held communicators;
interfacing a base station to the monitoring network, the base station including a first base station global positioning system (GPS) receiver associated with the base station, and a first base station radio frequency (RF) transceiver associated with the base station;
providing a second communicator GPS receiver and a second RF transceiver associated with each of the hand-held communicators; and
processing GPS and RF data received at the hand-held communicators to provide information relating to the plurality of predefined areas for communicating usage information relating to the plurality of predefined areas of the facility to the users.

20. A method as recited in claim 19 comprising the step of providing an electronic display for displaying information relating to the plurality of predefined areas of the facility in a graphic format at each of the hand-held communicators.

21. A recreational facility management system for monitoring users within a plurality of predefined areas of the facility for generating usage information, comprising:
means for processing facility management information obtained via a monitoring network;
means for portable hand-held communications;
means for transferring information from the facility management processing means to the portable hand-held communication means for sending information relating to the plurality of predefined areas to the communicating means;
means for interfacing a base station to the monitoring network;
first means for global positioning system (GPS) receiving associated with the base station;
a multiplicity of second means for GPS reception association with each of the hand-held communicator means;
first means for base station radio frequency (RF) transmission and reception associated with the base station;
a multiplicity of second means for RF transmission and reception, one each associated with each of said communicator means; and
a multiplicity of processing means associated with the communicators for processing the communicator GPS data received via said second communicator GPS receivers, base station GPS data received via said second RF transmission and reception means, and information relating to the plurality of predefined areas for communicating usage information relating to the plurality of predefined areas of the facility to the users.
